(19) United States
(12) Patent Application Publication
(10) Pub. No.: US 2008/0104241 A1
(43) Pub. Date: May 1, 2008

(54) TERMINAL DEVICE MANAGEMENT SYSTEM, DATA RELAY DEVICE, INTERNETWORK CONNECTION DEVICE, AND QUARANTINE METHOD OF TERMINAL DEVICE

(75) Inventors: Akihiro Kodama, Fukuoka (JP); Yuji Ito, Fukuoka (JP); Masaya Oda, Fukuoka (JP); Shinichi Kuranari, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/850,822

(22) Filed: Sep. 6, 2007

(30) Foreign Application Priority Data
Oct. 31, 2006 (JP) 2006-296772

(51) Int. Cl. G06F 15/173

(52) U.S. Cl. 709/225

(57) ABSTRACT

A proxy server includes a harmful site information memory portion storing source site identification information for identifying a Web site that provides harmful data, an access log memory portion storing a data obtaining log indicating which terminal device has obtained which data, an access control portion making the terminal device obtain the data that the terminal device tried to obtain if the data is not the harmful data provided by the Web site related to the source site identification information, and that refuses the terminal device to obtain the data if the data is the harmful data, a harmful site access terminal identifying portion identifying a terminal device that has obtained the harmful data provided by the source site related to new source site identification information, based on the data obtaining log, and a message transmitting portion requesting the router to perform a quarantine process for the identified terminal device.

### BACKGROUND OF THE INVENTION

1. Field of the Invention

The present invention relates to a system, a device, a method and the like for quarantining a terminal device.

2. Description of the Prior Art

Conventionally, Web pages that give harm to users are viewed as a problem. For example, there are Web pages on the Internet that can infect a computer with a virus only if its user browses the Web page with a Web browser and Web pages that can steal a password or personal information of the user by pretending to be a Web page of a financial institution, an application service provider (ASP), an online shopping or the like. If these Web pages are browsed, the computer will be in an abnormal state or confidential information will leak or other damage may occur.

A Web site that delivers a Web page that causes damage may be called a “harmful site” in general.

In order to prevent damage, it is simple and effective to prevent a computer from making access to harmful sites. Recent security management software for a personal computer is provided with a function called a “URL filter” that prohibits a computer from access to a harmful site. In an organization such as an office, a company or a school, a proxy server is usually used for inhibiting access to harmful sites in a unified manner. Alternatively, a router can be used for inhibiting access to harmful sites as described in Japanese unexamined patent publication No. 2002-73548.

As described in Japanese unexamined patent publication No. 2002-73548, a database that stores URLs of harmful sites is necessary in order to discriminate harmful sites.

However, a harmful site is not always found immediately after it is exposed on the Internet. There is possibility that a computer makes access to a newly exposed harmful site without being prohibited by a proxy server or a router during the period until the site is found and its URL is registered in the database.

Then, the computer may be damaged. Further, damages may be spread out to other computers that can communicate with the computer.

### SUMMARY OF THE INVENTION

An object of the present invention is to provide a system, a device and a method that can prevent damages caused by harmful sites more securely than the conventional ones.

A terminal device management system according to one aspect of the present invention includes an identification information storing portion that stores data identification information for identifying harmful data that can cause damage or source site identification information for identifying a source site that provides the harmful data, a data obtaining log storing portion that stores a data obtaining log indicating which terminal device has obtained which data or has obtained the data from which source site, a data obtaining control portion that makes a terminal device obtain data that the terminal device tries to obtain if the data is neither the harmful data related to the data identification information stored in the identification information storing portion nor the harmful data provided by the source site related to the source site identification information, and that refuses the terminal device to obtain the data if the data is at least one of the harmful data, a harmful data obtaining terminal device identifying portion that identifies a terminal device that has obtained the harmful data related to newly obtained data identification information or the harmful data provided by the source site related to newly obtained source site identification information, based on the data obtaining log stored in the data obtaining log storing portion, and a quarantine processing portion that performs a quarantine process for the terminal device identified by the harmful data obtaining terminal device identifying portion.

The data identification information indicates a whole or a part of a URL of the Web page including data that causes damage, for example. The source site identification information indicates a whole or a part of a URL of the Web site that provides the harmful Web page, for example.

According to the present invention, damage that may be caused by the harmful site can be prevented more securely than the conventional method. According to an aspect of the present invention, the quarantine target can be identified securely so that damage that may be caused by the harmful site can be prevented, even if the IP address of the terminal device is variable.

### BRIEF DESCRIPTION OF THE DRAWINGS

FIG. 1 is a diagram showing an example of a general structure of an intranet in a first embodiment.

FIG. 2 is a diagram showing an example of a functional structure of a proxy server in the first embodiment and a second embodiment.

FIG. 3 is a diagram showing an example of a functional structure of a router in the first embodiment and the second embodiment.

FIG. 4 is a diagram showing an example of a harmful site information memory portion.

FIG. 5 is a diagram showing an example of an access log memory portion.

FIG. 6 is a diagram showing an example of a format of a quarantine request message.

FIG. 7 is a diagram showing an example of a routing table.

FIG. 8 is a diagram showing an example of configuration definition information.

FIG. 9 is a flowchart for explaining an example of a flow of a process of the proxy server when it makes a request for quarantine.

FIG. 10 is a flowchart for explaining an example of a flow of a process of the proxy server when it makes a request for quarantine.

FIG. 11 is a flowchart for explaining an example of a flow of a quarantine process in the router that is connected to a terminal device directly.

FIG. 12 is a flowchart for explaining an example of a flow of the quarantine process in the router that is connected to the terminal device directly.

FIG. 13 is a diagram showing an example of a general structure of an intranet in the second embodiment.

FIG. 14 is a diagram showing an example of the routing table in the second embodiment.

FIG. 15 is a diagram showing an example of configuration definition information in the second embodiment.

FIG. 16 is a diagram showing an example of a functional structure of a switch in the second embodiment.

FIG. 17 is a diagram showing an example of a MAC address solution table.

FIG. 18 is a flowchart for explaining an example of a flow of a process of the router that is connected to the terminal device via the switch.

FIG. 19 is a flowchart for explaining an example of a flow of a process of the switch.

FIG. 20 is a diagram showing an example of a general structure of an intranet in a third embodiment.

FIG. 21 is a diagram showing an example of a functional structure of a router in the third embodiment.

FIG. 22 is a diagram showing an example of a functional structure of a switch in the third embodiment.

FIGS. 23A and 23B are diagrams showing an example of an address history table.

FIG. 24 is a flowchart for explaining an example of a flow of a quarantine process of the router that is connected to the terminal device directly.

FIG. 25 is a flowchart for explaining an example of a flow of the quarantine process of the router that is connected to the terminal device directly.

FIG. 26 is a flowchart for explaining an example of a flow of the quarantine process of the router that is connected to the terminal device directly.

FIG. 27 is a diagram showing an example of configuration definition information in the third embodiment.

FIG. 28 is a diagram showing an example of a quarantine request message in the third embodiment.

FIG. 29 is a diagram showing an example of a search request message.

FIGS. 30A-30C are diagrams showing an example of an address history table.

### DESCRIPTION OF THE PREFERRED EMBODIMENTS

The invention will now be described in detail with reference to the attached drawings.

### First Embodiment

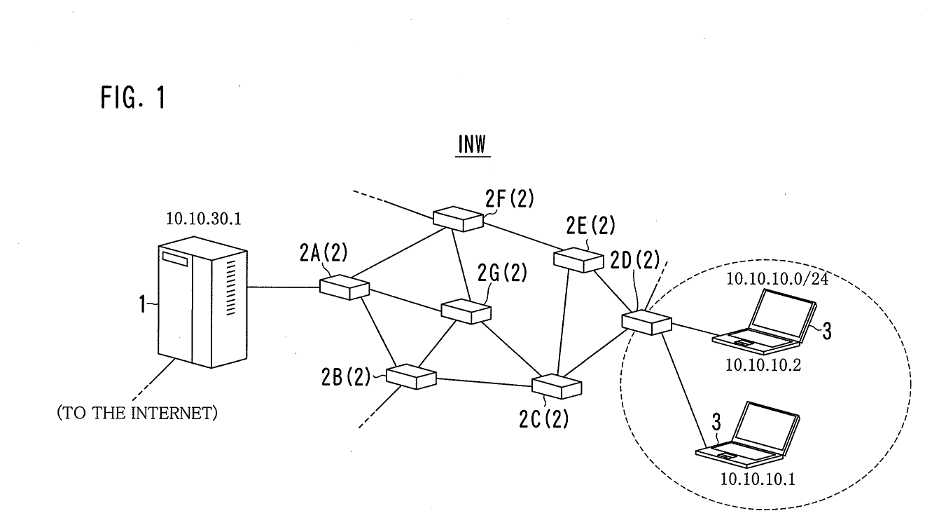

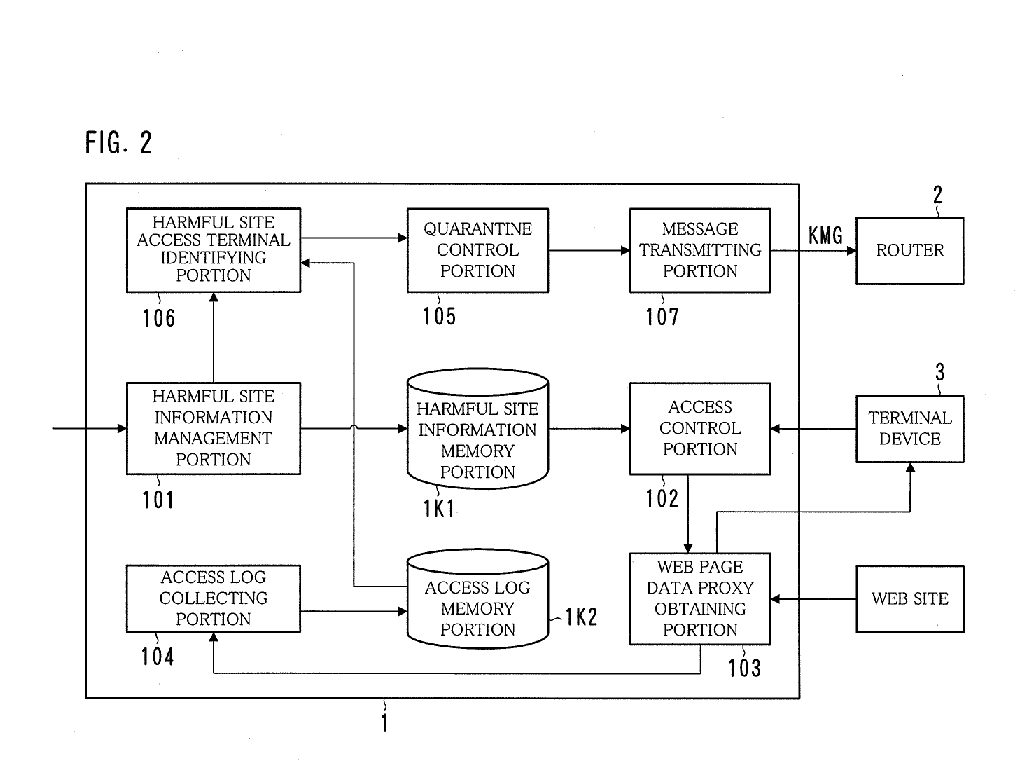

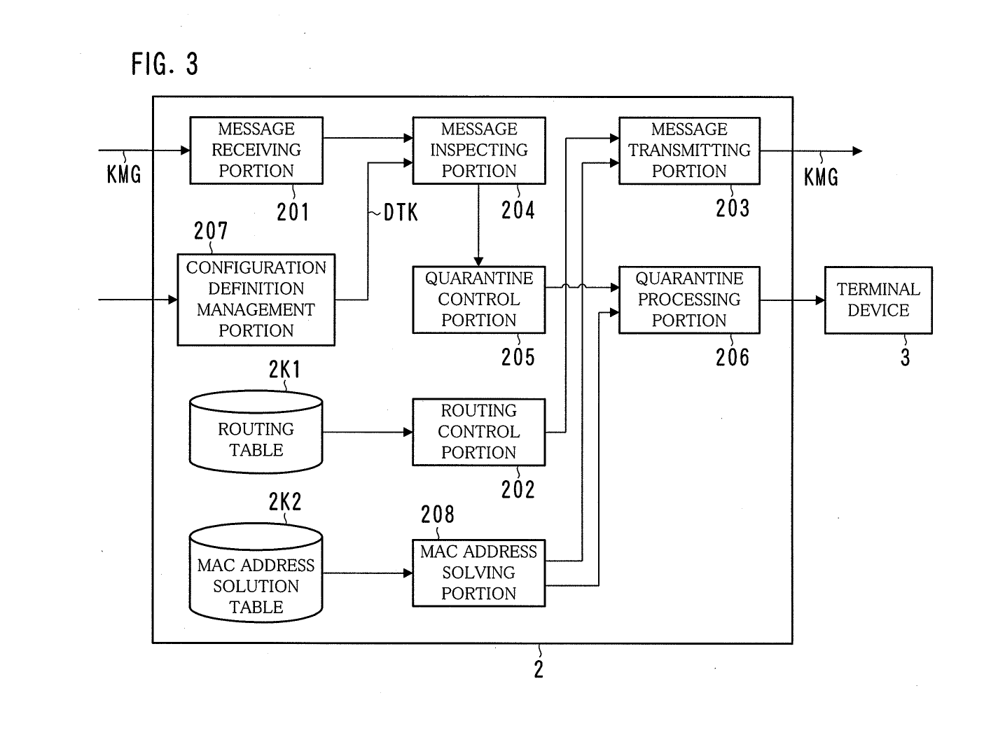

FIG. 1 is a diagram showing an example of a general structure of an intranet INW in a first embodiment, FIG. 2 is a diagram showing an example of a functional structure of a proxy server 1 in the first embodiment and a second embodiment, and FIG. 3 is a diagram showing an example of a functional structure of a router 2 in the first embodiment and the second embodiment.

The intranet INW is a network system to which a quarantine system according to the present invention is applied, and it is made up of the proxy server 1, a plurality of routers 2, a plurality of terminal devices 3 and the like as shown in FIG. 1. Each of the devices that constitute the intranet INW is assigned with a unique IP address and MAC address.

In addition, the intranet INW is divided into a plurality of LANs by the routers 2. This LAN may be called as a segment or a sub net.

The terminal device 3 is a client in which a Web browser is installed. As the terminal device 3, a personal computer, a workstation, a personal digital assistant (PDA) and the like are used. The Web browser is set so that Web pages can be obtained via the proxy server 1. Other applications that obtain data from servers on the Internet are also set in the same manner.

The proxy server 1 is made up of a harmful site information management portion 101, an access control portion 102, a Web page data proxy obtaining portion 103, an access log collecting portion 104, a quarantine control portion 105, a harmful site access terminal identifying portion 106, a message transmitting portion 107, a harmful site information memory portion 1K1, an access log memory portion 1K2 and the like as shown in FIG. 2.

With this structure, the proxy server 1 obtains data sent from a Web server or the like on the Internet requested by the terminal device 3 and transmits the same to the terminal device 3 as a relay process.

Further, the proxy server 1 does not make access to a Web site that sends a harmful Web page such as a Web page that infects a computer that made access to that Web page with a virus or a Web page designed to steal information. Hereinafter, the Web site sending such a harmful Web page is referred to as a “harmful site”. Therefore, the proxy server 1 refuses to relay data of the Web page if the terminal device 3 requests the Web page that is sent from the harmful site. Thus, the data from the harmful site is prevented from entering the intranet INW, so that damage to the terminal device 3 can be prevented.

This function of inhibiting access to a harmful site is provided to the conventional proxy server, too. However, the proxy server 1 is further devised to prevent damage more securely due to data of a Web page sent from a harmful site. This will be described later.

The router 2 is an internetwork connection device for connecting a plurality of LANs to each other. The router 2 is equipped with one or more RJ-45 connectors for connecting to other router 2 and one or more RJ-45 connectors for connecting to the terminal device 3. Hereinafter, the RJ-45 connector for connecting to other router 2 is referred to as an “external connection connector”, and the RJ-45 connector for connecting to the terminal device 3 is referred to as an “internal connection connector”.

The terminal devices 3 that are connected to the internal connection connectors of one router 2 make up one LAN. From the standpoint of the router 2, the LAN made up of terminal devices 3 connected to its internal connection connectors is regarded as an internal network. In addition, any one of the routers 2 is connected to the proxy server 1.

Hereinafter, the individual routers 2 provided to the intranet INW may be referred to as a “router 2A”, a “router 2B”, a “router 2C” and so on in a differentiated manner. In addition, internal networks for the router 2A, the router 2B, the router 2C and so on may be referred to as an “internal network NA”, an “internal network NB”, an “internal network NC” and so on.

Further, the router 2 is provided with a message receiving portion 201, a routing control portion 202, a message transmitting portion 203, a message inspecting portion 204, a quarantine control portion 205, a quarantine processing portion 206, a configuration definition management portion 207, a MAC address solving portion 208, a routing table 2K1, a MAC address solution table 2K2 and the like as shown in FIG. 3.

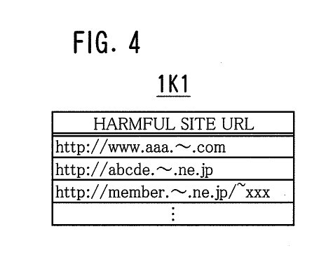

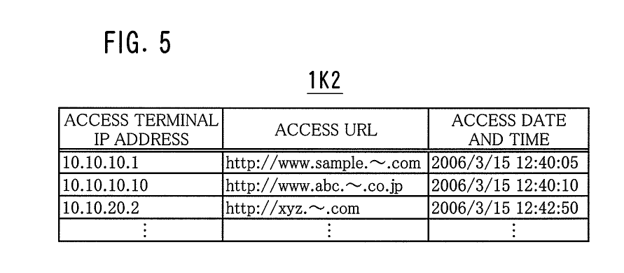

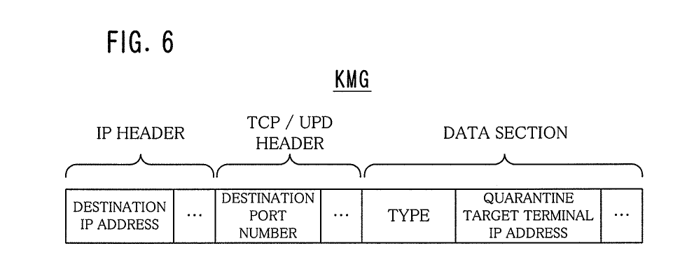

FIG. 4 is a diagram showing an example of the harmful site information memory portion 1K1, FIG. 5 is a diagram showing an example of the access log memory portion 1K2, and FIG. 6 is a diagram showing an example of a format of a quarantine request message KMG.

Next, process contents and the like of the individual portions of the proxy server 1 shown in FIG. 2 and the individual portions of the router 2 shown in FIG. 3 will be described in detail.

In FIG. 2, the harmful site information memory portion 1K1 of the proxy server 1 stores information about Web sites to which accesses are inhibited, i.e., harmful sites. More specifically, a list that indicates URLs of the harmful sites is stored as shown in FIG. 4.

The harmful site information management portion 101 registers a URL of a newly found harmful site in the harmful site information memory portion 1K1, deletes a URL of a vanished harmful site from the harmful site information memory portion 1K1, and other management of URLs of the harmful site.

The work of registering a URL of a harmful site in the harmful site information memory portion 1K1 and deleting a URL from the same are performed by an administrator of the intranet INW. Alternatively, it is possible to obtain information of new harmful sites and vanished harmful sites from a company that monitors harmful sites and collects their information and to do management of the harmful site information memory portion 1K1 based on the obtained information.

The Web page data proxy obtaining portion 103 obtains data of a Web page to which the terminal device 3 tried to make access from the Web server on the Internet on behalf of the terminal device 3 and gives the obtained data to the terminal device 3. In other words, it performs a process of proxy for obtaining data of the Web page.

The access control portion 102 checks whether or not the source site of the Web page to which the terminal device 3 tried to make access is a harmful site based on the list stored in the harmful site information memory portion 1K1. If the source site is a harmful site, it makes the Web page data proxy obtaining portion 103 stop the process for obtaining data of the Web page and giving the same to the terminal device 3. If the source site is not a harmful site, it makes the Web page data proxy obtaining portion 103 perform the process for obtaining data of the Web page. In other words, the access control portion 102 performs control of access to a Web site on the Internet.

The access control portion 102 and the Web page data proxy obtaining portion 103 perform the above-mentioned process in the following procedure.

When a user clicks a hyperlink with a mouse or enters characters with a keyboard to designate a URL in the Web browser of the terminal device 3, the terminal device 3 informs the proxy server 1 of the designated URL and requests the proxy server 1 to send a Web page of the URL.

Then, the access control portion 102 of the proxy server 1 discriminates whether or not the source site of the Web page of the URL informed by the terminal device 3 is a harmful site that is stored in the harmful site information memory portion 1K1.

For example, if the harmful site information memory portion 1K1 stores two URLs, “http://www.aaa.ppp.qqq” and “http://www.aaa.rrr.sss”, it is checked whether or not one of them is included in the URL that is informed by the terminal device 3. If one of them is included, it is decided that the source site of the Web page of the informed URL is a harmful site. If they are not included, it is decided that the source site is not a harmful site.

Then, if it is decided that the source site is a harmful site, the process of obtaining data of the Web page of the URL and giving the same to the terminal device 3 is stopped. On the contrary, if it is decided that the source site is not a harmful site, the URL is informed to the Web page data proxy obtaining portion 103.

Then, the Web page data proxy obtaining portion 103 makes access to the Web server based on the URL, downloads data of the Web page, and transmits the data to the terminal device 3 that made the request.

If the data of the Web page that is requested by the terminal device 3 is already obtained and cached, the data may be given to the terminal device 3 that made the request, without making access to the Web site.

The access log memory portion 1K2 stores a URL of a Web page to which the Web page data proxy obtaining portion 103 made access on behalf of the terminal device 3 (access URL), date and time when the access is made (access date and time) and information of the IP address of the terminal device 3 (access terminal IP address) as shown in FIG. 5.

The access log collecting portion 104 registers a record that indicates the URL of the Web page, the IP address of the terminal device 3, the date and time when the data of the Web page was given (i.e., the access date and time when the terminal device 3 made access to the Web page) in the access log memory portion 1K2, every time when the data of the Web page is given to the terminal device 3 in accordance with the request from the terminal device 3. In other words, it collects a log of access to the Web page.

As described above, a harmful site is not always found immediately after it is exposed on the Internet. There is a case where even a company that monitors harmful sites cannot find a harmful site until a certain time has passed after it is exposed.

Therefore, there is possibility that the terminal device 3 makes access to a newly exposed harmful site during the period after the harmful site is exposed until it is found and its URL is registered in the harmful site information memory portion 1K1.

Therefore, the quarantine control portion 105, the harmful site access terminal identifying portion 106 and the message transmitting portion 107 find out a terminal device 3 that has made access to such a harmful site before the finding and cooperate with the router 2 to perform a process for quarantining the terminal device 3.

The quarantine control portion 105 controls the harmful site access terminal identifying portion 106 and the message transmitting portion 107 as follows so as to perform a process for quarantine.

When a URL of a new harmful site is registered in the harmful site information memory portion 1K1, the quarantine control portion 105 instructs the harmful site access terminal identifying portion 106 to identify the terminal device 3 that has made access to any Web page of the harmful sites (i.e., that has obtained data of the Web page of the harmful site via the Web page data proxy obtaining portion 103).

Then, the harmful site access terminal identifying portion 106 analyzes the log stored in the access log memory portion 1K2 (see FIG. 5) so as to identify such terminal devices 3.

For example, if the URL of the new harmful site is “http://aaa.bbb.ccc”, the terminal devices 3 that have made access to the Web page of the URL including the URL of the harmful site such as “http://aaa.bbb.ccc/ddd.html”, “http://www.aaa.bbb.ccc/eee/fff.html”, “http://www.aaa.bbb.ccc”, “http://www.aaa.bbb.ccc/ggg.html” or “http://aaa.bbb.ccc” are identified by analyzing the URL indicated in the log.

When the harmful site access terminal identifying portion 106 identifies the terminal devices 3, the quarantine control portion 105 requests the message transmitting portion 107 to generate a message requesting (instructing) quarantine of the terminal device 3 and to transmit the message.

Then, the message transmitting portion 107 generates the quarantine request message KMG and transmits it to the routers 2 that are connected to the proxy server 1 itself.

The quarantine request message KMG is generated and is transmitted based on the TCP/IP protocol. Therefore, the quarantine request message KMG is made up of an IP header, a TCP/UDP header, a data section and the like as shown in FIG. 6.

The IP header indicates a destination IP address, a source IP address and the like in the same manner as the conventional one. In particular, an IP address of the terminal device 3 identified by the harmful site access terminal identifying portion 106 is set in the destination IP address.

The TCP/UDP header indicates a destination port number, a source port number and the like in the same manner as the conventional one. In particular, a port number in the application layer of the service that is requested this time, i.e., a quarantine service is set in the destination port number. The port number of the quarantine service should be decided in the intranet INW in advance.

The data section indicates information of a type, a quarantine target terminal IP address and the like. The “type” indicates an identifier of the process requested by the message. Here, an identifier that indicates a request of quarantine is indicated. The “quarantine target terminal IP address” indicates an IP address of the terminal device 3 to be a target of quarantine, which is identified by the harmful site access terminal identifying portion 106.

If the harmful site access terminal identifying portion 106 identifies a plurality of terminal devices 3, one quarantine request message KMG is generated and transmitted for each of the terminal devices 3. The quarantine request message KMG that is transmitted to the router 2 that is connected to the proxy server 1 is directed to the terminal device 3 of the destination IP address via other routers 2 if necessary in the same manner as the conventional one.

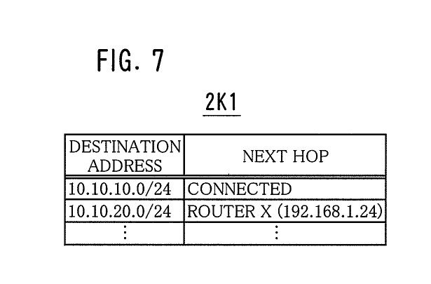

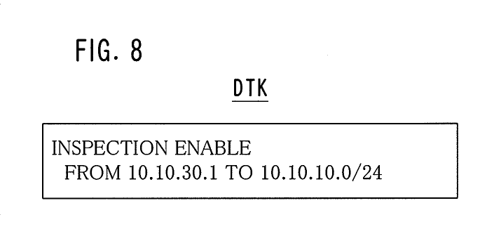

FIG. 7 is a diagram showing an example of a routing table 2K1, and FIG. 8 is a diagram showing an example of configuration definition information DTK.

As shown in FIG. 3, the routing table 2K1 of the router 2 stores data that indicates the route to which the IP packets received from the proxy server 1, the terminal device 3 or other router 2 should be transmitted. For example, the routing table 2K1 of the router 2D that is connected to the internal connection connector of the internal network ND having the network address “10.10.10.0” stores data as shown in FIG. 7.

If a value of a “Next HoP” field of a LAN (segment, sub net) indicated in the “destination address” field is “Connected”, it means that the LAN is the internal network of the router 2.

The message receiving portion 201 performs a process of receiving various IP packets of messages and the like transmitted from the proxy server 1, the terminal device 3, other router 2 or the like.

The routing control portion 202 decides the device to which the IP packet received by the message receiving portion 201 should be transmitted, based on the routing table 2K1. In other words, it performs control of the IP packet routing. In addition, the routing control portion 202 checks the terminal device 3 that is currently connected to the router 2 and is able to communicate.

The MAC address solution table 2K2 stores learned data that indicates a current relationship between the MAC address and the IP address for each of the proxy server 1, the terminal device 3 and other router 2 that is connected to the router 2.

The MAC address solving portion 208 discriminates the MAC address corresponding to the IP address indicated in the IP packet based on the routing table 2K1.

The message transmitting portion 203 transmits the IP packet received by the message receiving portion 201 or the IP packet generated by the router 2 to the destination decided by the routing control portion 202 (the proxy server 1, the terminal device 3, or other router 2). The MAC address of the destination is obtained by inquiring the MAC address solving portion 208. However, there is a case where the quarantine request message KMG received by the message receiving portion 201 is not transmitted to other device but is processed by the router 2 as described later.

In this way, the IP packet except the particular message such as the quarantine request message KMG is processed by the routing table 2K1, the MAC address solution table 2K2, the message receiving portion 201, the routing control portion 202, the message transmitting portion 203, the MAC address solving portion 208 or the like in the same manner as the conventional one. Whether or not the IP packet is the quarantine request message KMG is known by checking the destination port number of the IP packet.

The configuration definition management portion 207 sets the configuration definition information DTK and manages the same. This configuration definition information DTK defines that, in response to what kind of attribution of the received quarantine request message KMG, the router 2 should perform the quarantine process.

For example, the configuration definition management portion 207 of the router 2D manages the configuration definition information DTK as shown in FIG. 8. This configuration definition information DTK includes syntax of “from IP address to network address/network address length”. The “IP address” indicates an IP address of the proxy server 1, the “network address” indicates a network address of the internal network of the router 2 (the router 2D in the example shown in FIG. 8), and the “network address length” indicates a bit length of the network address.

This means that the router 2 performs the quarantine process if a source IP address of the received quarantine request message KMG matches the IP address just after the “from” indicated in the configuration definition information DTK (i.e., the source of the quarantine request message KMG is the proxy server 1), and a destination IP address of the quarantine request message KMG is an IP address that belongs to the internal network defined by the network address just after “to” indicated in the configuration definition information DTK and the network address length (i.e., the destination of the quarantine request message KMG is any terminal device 3 of the internal network of the router 2).

The configuration definition information DTK set by the configuration definition management portion 207 is informed to the quarantine control portion 205 and further to the message inspecting portion 204.

The message inspecting portion 204 inspects whether or not a source of the quarantine request message KMG received by the message receiving portion 201 is the proxy server 1, and whether or not a quarantine target indicated in the quarantine request message KMG is the terminal device 3 that belongs to the internal network of the router 2 itself, based on the configuration definition information DTK.

More specifically, it compares the source IP address of the quarantine request message KMG with the IP address just after “From” indicated in the configuration definition information DTK, so as to inspect whether or not the source of the quarantine request message KMG is the proxy server 1. In addition, it compares the search target terminal IP address of the quarantine request message KMG with the network address just after “to” indicated in the configuration definition information DTK, so as to inspect whether or not the quarantine target is the terminal device 3 that belongs to the internal network of the router 2 itself.

When it is found that the source of the quarantine request message KMG received by the message receiving portion 201 is the proxy server 1 and that the quarantine target indicated in the quarantine request message KMG is the terminal device 3 that belongs to the internal network (that is included in the internal network) of the router 2 as a result of the inspection performed by the message inspecting portion 204, the quarantine control portion 205 performs the quarantine process of the terminal device 3 that has made access to the harmful site, in the following procedure.

It inquires the routing control portion 202 about whether or not communication is possible with the terminal device 3 of the quarantine target indicated in the quarantine request message KMG.

If the communication is possible, it instructs the quarantine processing portion 206 to perform the quarantine process for the terminal device 3 that is a quarantine target.

The quarantine processing portion 206 performs the quarantine process for the terminal device 3 of the quarantine target terminal IP address in the quarantine request message KMG based on the instruction from the quarantine control portion 205. The method of the quarantine process itself is known. For example, communication of the terminal device 3 is limited to one concerning the quarantine process so that the terminal device 3 is isolated and virus check or the like is performed for the terminal device 3. Further, destruction of virus, update of the vaccine, update of the operating system and the like are performed, if necessary.

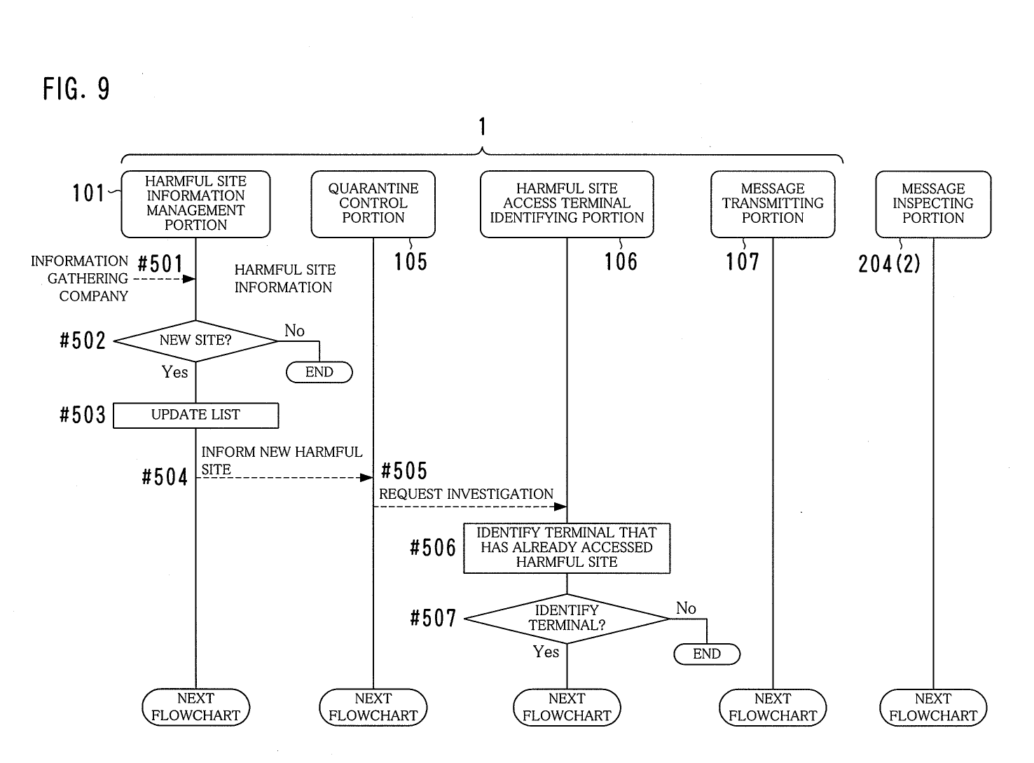

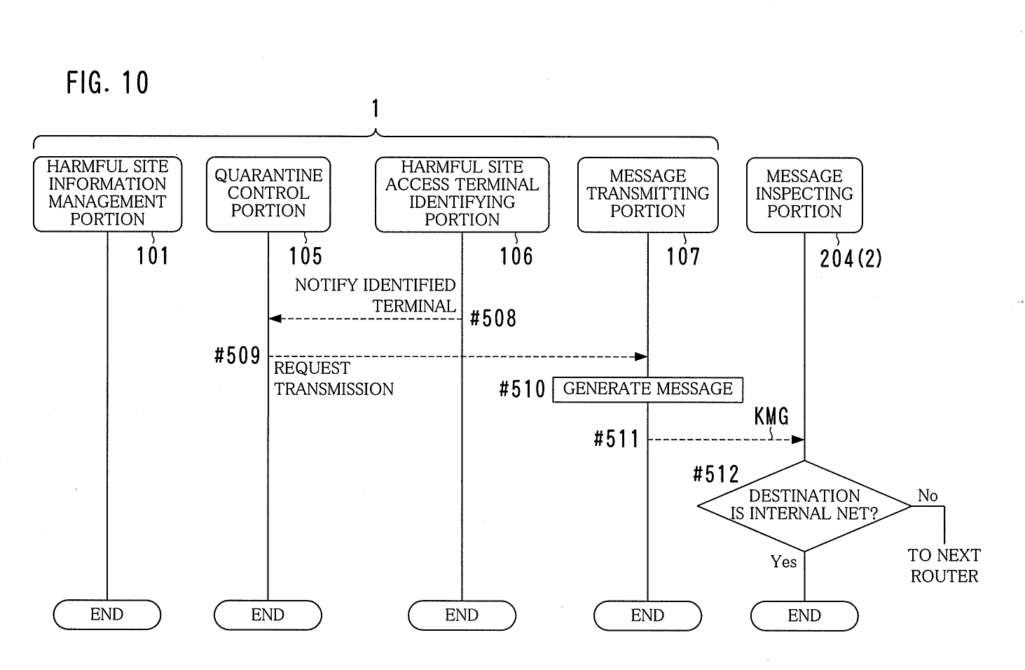

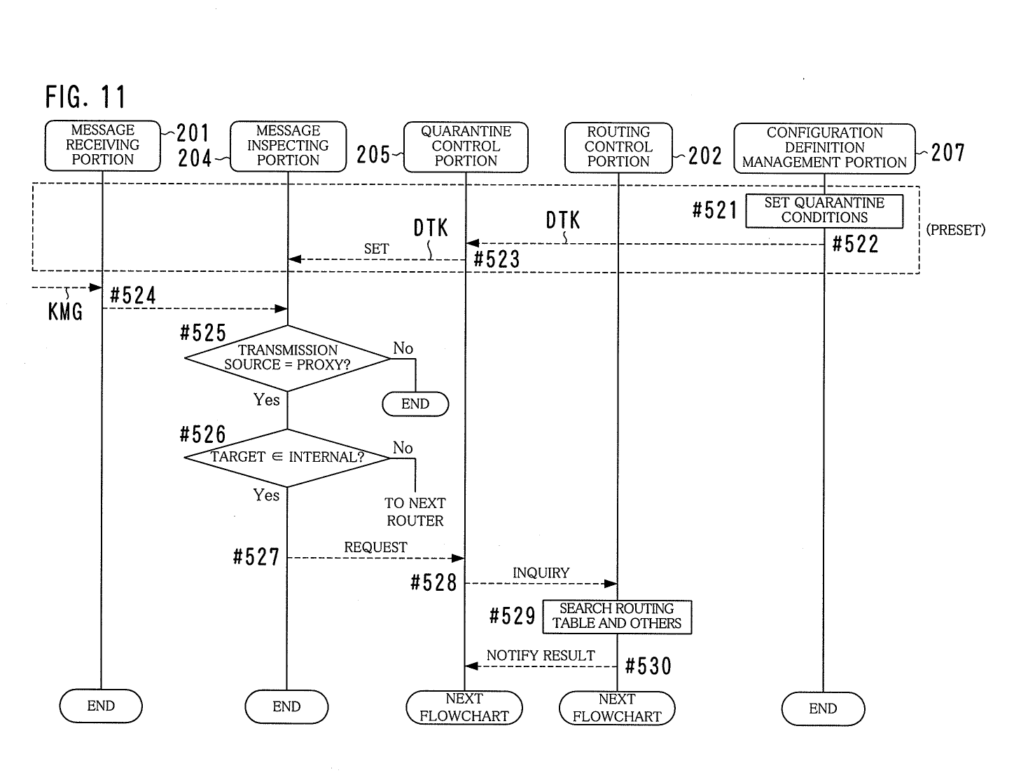

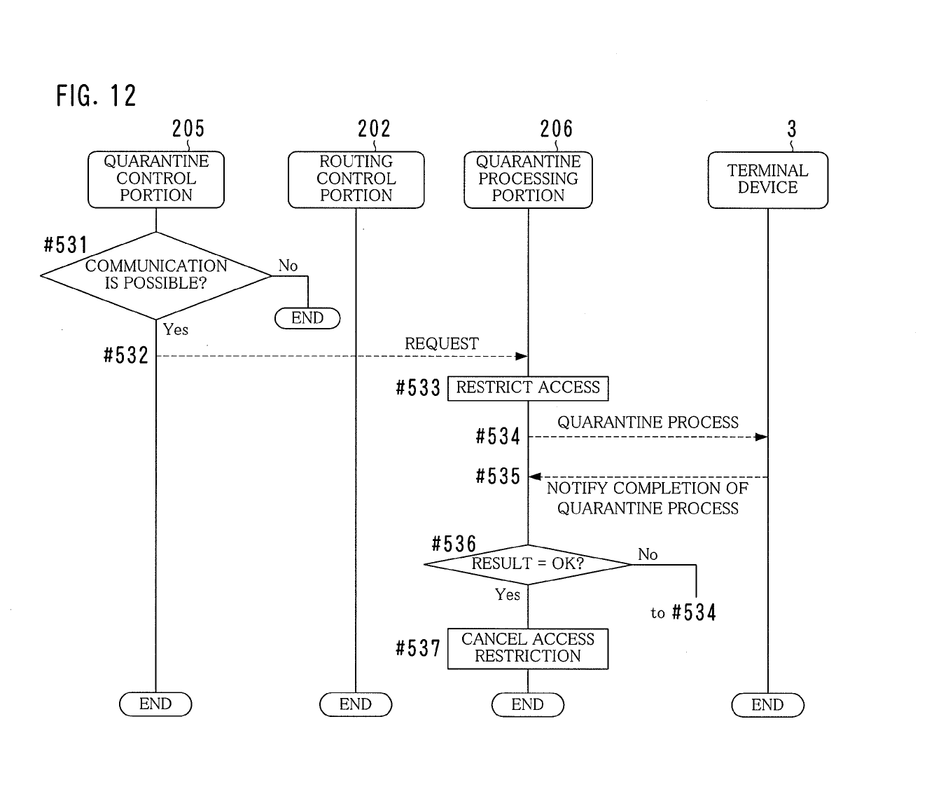

FIGS. 9 and 10 are flowcharts for explaining an example of a flow of a process of the proxy server 1 when it makes a request for quarantine, FIGS. 11 and 12 are flowcharts for explaining an example of a flow of the quarantine process performed by the router 2 in the case where it is connected to the terminal device 3 directly.

Next, flows of processes performed by the proxy server 1 and the router 2 in the first embodiment will be described with reference to flowcharts shown in FIGS. 9-12.

In FIG. 9, when information of a harmful site is supplied to the proxy server 1 from a company that monitors harmful sites and collects their information (#501), the harmful site information management portion 101 enrolls newly the URL of the harmful site in the harmful site information memory portion 1K1 (#503) if the harmful site that is not registered in the harmful site information memory portion 1K1 is included in the information (Yes in #502). Further, it informs the quarantine control portion 105 of the newly found harmful site (#504).

Then, the quarantine control portion 105 requests the harmful site access terminal identifying portion 106 to investigate whether or not there is a terminal device 3 that is already provided with a Web page from the harmful site (#505).

The harmful site access terminal identifying portion 106 compares access logs of the terminal devices 3 accumulated in the access log memory portion 1K2 with a URL of the harmful site, so as to identify the terminal device 3 that is already provided with a Web page from the harmful site (#506).

If the terminal device 3 was identified (Yes in #507), the process goes to the flowchart shown in FIG. 10, and the terminal device 3 is informed to the quarantine control portion 105 (#508).

The quarantine control portion 105 requests the message transmitting portion 107 to generate and to transmit the quarantine request message KMG that indicates that quarantine of the terminal device 3 should be performed (#509). Then, the message transmitting portion 107 generates the quarantine request message KMG having the format as shown in FIG. 6 (#510) and sends the same to the router 2 to which the proxy server 1 itself is connected (#511).

In the router 2, when the message receiving portion 201 receives the quarantine request message KMG transmitted from the proxy server 1, the message inspecting portion 204 checks whether or not it is related to the request for quarantine of the terminal device 3 that belongs to (that is included in) the internal network of the router 2 (#512).

If it is related to the request for quarantine of the terminal device 3 that belongs to the internal network of the router 2 (Yes in #512), a series of processes concerning quarantine of the terminal device 3 is started. The procedure of this process will be described next with reference to FIGS. 11 and 12. If it is related to the request for quarantine of the terminal device 3 that belongs to other LAN (No in #512), the quarantine request message KMG is transmitted to other router 2.

The router 2 performs a series of processes concerning quarantine in the procedure as shown in FIGS. 11 and 12.

In FIG. 11, the router 2 performs the following process in advance for preparation for the series of processes concerning quarantine. The configuration definition management portion 207 sets the configuration definition information DTK as shown in FIG. 8 (#521) and informs it to the quarantine control portion 205 (#522). The quarantine control portion 205 sets the configuration definition information DTK in the message inspecting portion 204 in advance (#523).

When the message receiving portion 201 receives the quarantine request message KMG from the proxy server 1 or other router 2 (#524), the message inspecting portion 204 inspects whether or not the source of the quarantine request message KMG is the proxy server 1 and is related to the request for quarantine of the terminal device 3 that belongs to the internal network of the router 2 (#525, #526). If the both conditions are satisfied (Yes in #525 and Yes in #526), it requests the quarantine control portion 205 to perform the quarantine of the terminal device 3 that is the quarantine target indicated in the quarantine request message KMG (#527).

On the other hand, if the terminal device 3 that belongs to other LAN is the quarantine target (No in #526), the message transmitting portion 203 sends the quarantine request message KMG to the other router 2 based on the destination IP address.

When the quarantine control portion 205 receives the request from the message inspecting portion 204, it inquires the routing control portion 202 about whether or not it is currently able to communicate with the terminal device 3 of the quarantine target (#528). The routing control portion 202 checks whether or not it is currently able to communicate with the terminal device 3 by searching the IP address of the terminal device 3 from the routing table 2K1 or by other method (#529), and it informs the result to the quarantine control portion 205 (#530).

The process goes to the flowchart shown in FIG. 12. If it is able to communicate with the terminal device 3 of the quarantine target (Yes in #531), the quarantine control portion 205 requests the quarantine processing portion 206 to perform the quarantine process of the terminal device 3 (#532).

Then, the quarantine processing portion 206 starts the quarantine process of the terminal device 3. More specifically, first, communication of the terminal device 3 is limited to one concerning the quarantine process, so that the access of the terminal device 3 is restricted (#533). In other words, the terminal device 3 is isolated.

The virus check, the destruction of virus, update of vaccine, update of the operating system or the like is performed for the terminal device 3, so that the quarantine process is performed (#534). When a notice indicating that the quarantine process is finished is received from the terminal device 3 (#535), it is checked whether or not the terminal device 3 has a problem. If it has no problem (Yes in #536), the limitation of access is canceled (#537).

According to the first embodiment, the terminal device 3 that has already made access to the newly found harmful site can be quarantined. Therefore, damage that may be caused by the harmful site can be prevented more securely than the conventional method.

It is possible to adopt a structure in which the router 2 after being quarantined or the terminal device 3 after being quarantined sends a report of finishing to the proxy server 1. In addition, it is possible to adopt a structure in which if the report is not received after a predetermined time has passed, the proxy server 1 sends the quarantine request message KMG again for requesting the quarantine of the terminal device 3. According to this structure, even if the power is turned off temporarily or the network function is stopped, the quarantine process of the terminal device 3 can be retried later.

### Second Embodiment

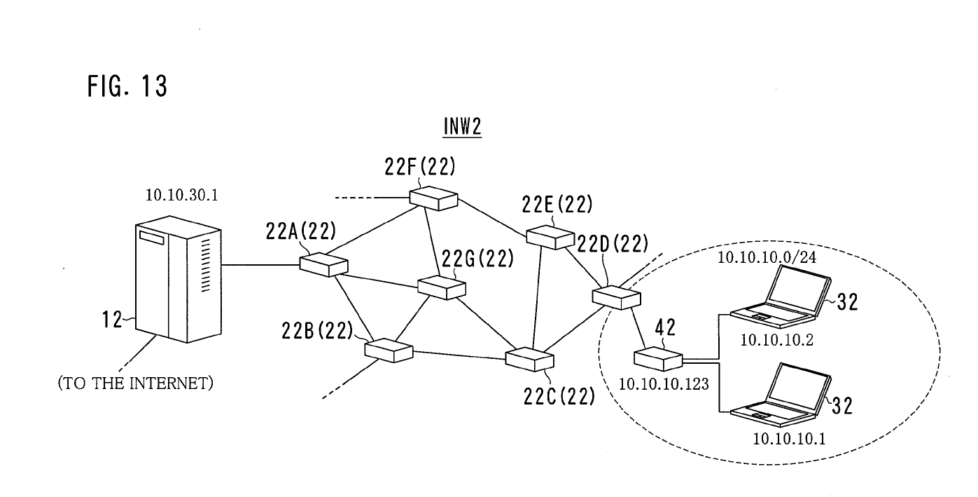

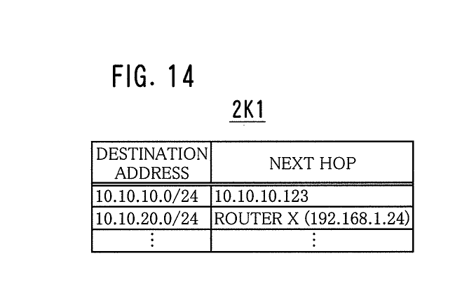

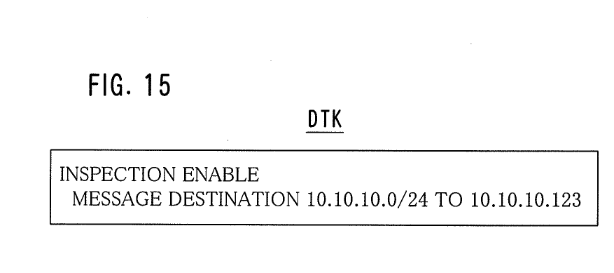

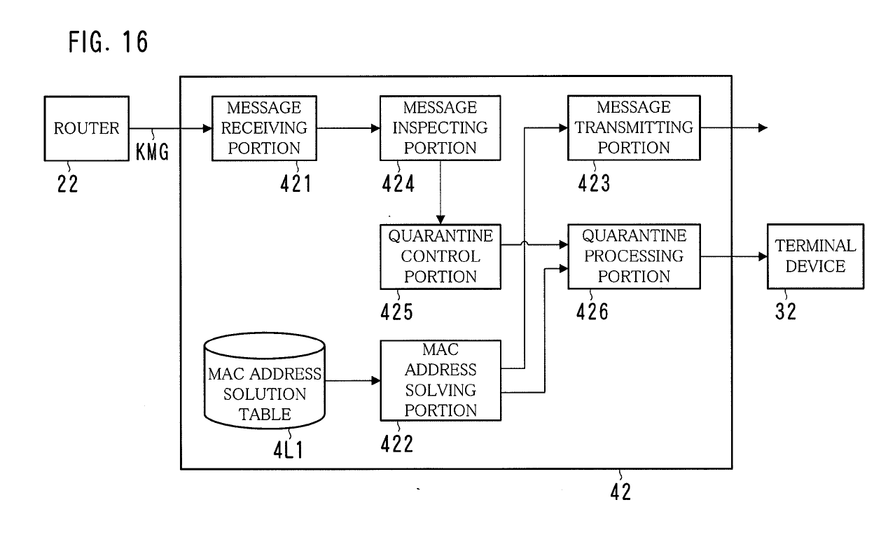

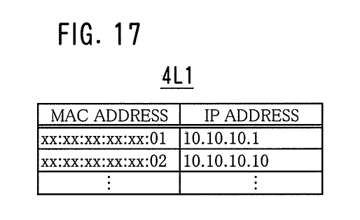

FIG. 13 is a diagram showing an example of a general structure of an intranet INW2 in a second embodiment, FIG. 14 is a diagram showing an example of the routing table 2K1 in the second embodiment, FIG. 15 is a diagram showing an example of the configuration definition information DTK in the second embodiment, FIG. 16 is a diagram showing an example of a functional structure of a switch 42 in the second embodiment, and FIG. 17 is a diagram showing an example of a MAC address solution table 4L1.

In the first embodiment, the terminal device 3 is connected to the router 2 directly. As to the second embodiment, a case where an L2 switch (also referred to as an “LAN switch”, a “layer II switch” or the like) is provided between the devices will be described.

As shown in FIG. 13, the intranet INW2 according to the second embodiment is made up of a proxy server 12, a plurality of routers 22 (22A, 22B, 22C and so on), a plurality of terminal devices 32, a plurality of switches 42 and the like.

The connection form between the proxy server 12 and each of the routers 22 is the same as that in the case of the first embodiment. The internal connection connector of the router 22 is connected to the switch 42. Further, the RJ-45 connector of the switch 42 is connected to one or more terminal devices 32. From the standpoint of the router 22, the LAN that is made up of the terminal devices 32 that are connected to the switch 42 that is connected to its internal connection connector can be said to be the internal network.

Structures of the proxy server 12 and the router 22 are basically the same as those of the proxy server 1 and the router 2 in the first embodiment described above with reference to FIGS. 2 and 3.

However, the device that is connected to the internal connection connector of the router 22 is different from the case in the first embodiment, so contents of the routing table 2K1 of the router 22 and contents of the configuration definition information DTK are different from those of the case in the first embodiment.

For example, the routing table 2K1 of the router 22D stores the IP address of the switch 42 that is connected to the router 22D, as the destination of the IP packet to be sent to the IP address of the internal network, as shown in FIG. 14.

In addition, the configuration definition information DTK that is managed by the configuration definition management portion 207 of the router 22D includes a definition that the quarantine request message KMG to be sent to the IP address that belongs to the internal network ND should be transmitted to the switch 42 connected to the router 22D as shown in FIG. 15.

If the contents of the configuration definition information DTK is defined as shown in FIG. 15, a part of the router 22 shown in FIG. 3 operates differently from the case in the first embodiment. This will be described later with reference to a flowchart.

Note that the terminal device 32 may be connected directly to the internal connection connector of the router 22. In this case, the quarantine method and the method of transmitting the quarantine request message KMG are the same as described above in the first embodiment, so overlapping description will be omitted. A structure of the terminal device 32 is the same as that of the terminal device 3 in the first embodiment.

The switch 42 is the L2 switch, and at least two RJ-45 connectors are provided. One of the RJ-45 connectors is connected to the terminal device 32, and the rest of the RJ-45 connectors are connected to the terminal device 32.

Further, the switch 42 is provided with a message receiving portion 421, a MAC address solving portion 422, a message transmitting portion 423, a message inspecting portion 424, a quarantine control portion 425, a quarantine processing portion 426, a MAC address solution table 4L1 and the like as shown in FIG. 16.

Hereinafter, process contents of the individual portions of the router 22 and the switch 42 will be described. Descriptions overlapping with the first embodiment will be omitted.

The MAC address solution table 4L1 stores learned data that indicates a current relationship between the MAC address and the IP address of each of the terminal devices 32 and the routers 22 that are connected to the switch 42 as shown in FIG. 17.

The message receiving portion 421 performs a process of receiving various IP packets such as messages transmitted from the routers 22 or the terminal devices 32 that are connected to the switch 42.

The MAC address solving portion 422 decides the MAC address of the terminal device 32 to which the IP packet received by the message receiving portion 201 or generated by the switch 42 should be transmitted, based on the MAC address solution table 4L1.

The message transmitting portion 423 transmits the IP packet to the terminal device 32 that has the MAC address decided by the MAC address solving portion 422, in the same manner as the conventional method. However, there is a case where the quarantine request message KMG is not transmitted to the terminal device 32 but is processed in the switch 42, as described later.

In this way, the IP packet except the particular message such as the quarantine request message KMG is processed by the MAC address solution table 4L1, the message receiving portion 421, the MAC address solving portion 422 and the message transmitting portion 423 in the same manner as the conventional method. Whether or not the IP packet is the quarantine request message KMG is found by checking the destination port number of the IP packet in the same manner as the case in the first embodiment.

The message inspecting portion 424 performs the same process as the message inspecting portion 204 of the router 22 (see FIG. 3). Therefore, it is inspected whether or not the source of the quarantine request message KMG received by the message receiving portion 421 is the proxy server 12, and whether or not the quarantine target indicated in the quarantine request message KMG is the terminal device 32 that is connected to (is included in) the switch 42.

The quarantine control portion 425 performs the process for quarantine of the terminal device 32 that has made access to the harmful site, in the following procedure, if the message inspecting portion 204 decides that the source of the quarantine request message KMG received by the message receiving portion 421 is the proxy server 12, and that the quarantine target indicated in the quarantine request message KMG is the terminal device 32 that is connected to the switch 42.

The quarantine control portion 425 inquires the MAC address solving portion 422 about whether or not it is possible at the present to communicate with terminal device 32.

Then, the MAC address solving portion 422 decides that it is possible to communicate with the terminal device 32 at present if the IP address of the terminal device 32 (i.e., the quarantine target terminal IP address indicated in the quarantine request message KMG) is indicated in the MAC address solution table 4L1 (see FIG. 17) at present, and that it is not possible to communicate if the IP address is not indicated in the same.

The quarantine control portion 425 instructs the quarantine processing portion 426 to perform the quarantine process of the terminal device 32 if the MAC address solving portion 422 decides that it is possible to communicate with the terminal device 32.

Then, the quarantine processing portion 426 performs the quarantine process of the terminal device 32 in the same manner as the quarantine processing portion 206 of the router 22.

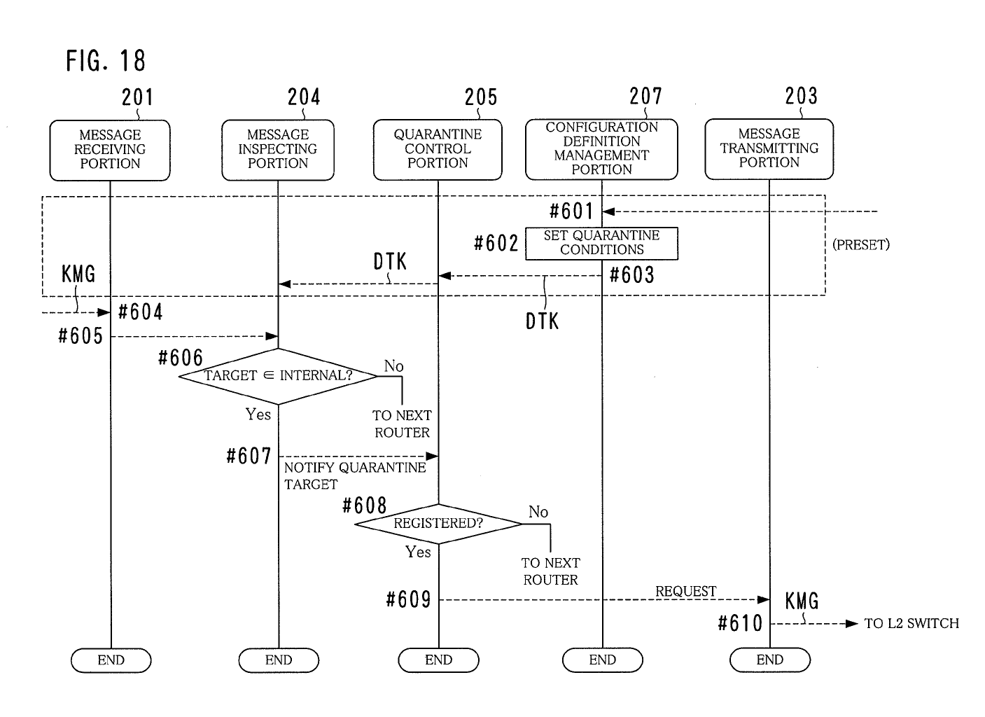

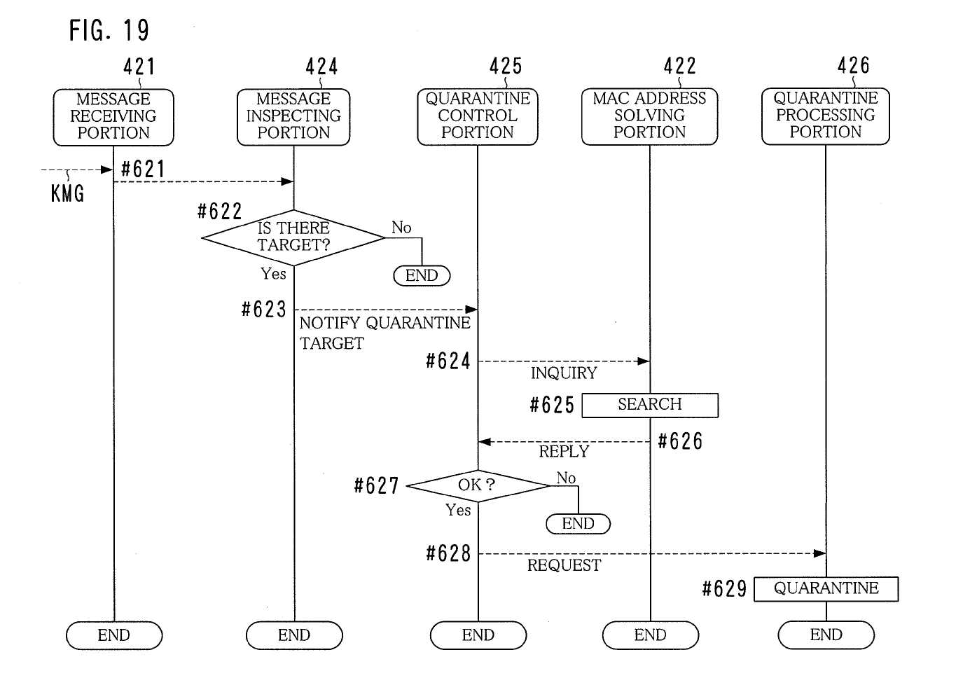

FIG. 18 is a flowchart for explaining an example of a flow of a process of the router 2 that is connected to the terminal device 32 via the switch 42, and FIG. 19 is a flowchart for explaining an example of a flow of a process of the switch 42.

Next, flows of the processes performed by the router 22 and the switch 42 in the second embodiment will be described with reference to flowcharts shown in FIGS. 18 and 19. A flow of the process performed by the proxy server 12 is the same as the flow of the process performed by the proxy server 1 in the first embodiment, so the description thereof will be omitted.

As shown in FIG. 18, the configuration definition management portion 207 of the router 22 receives the configuration definition information DTK as shown in FIG. 15, which is entered by the administrator for preparation for the series of processes concerning the quarantine, in the same manner as the case in the first embodiment (#601, #602), and informs it to the quarantine control portion 205 and the message inspecting portion 204 (#603).

When the message receiving portion 201 receives the quarantine request message KMG from the proxy server 12 or other router 22 (#604), the message inspecting portion 204 inspects the quarantine request message KMG in the same manner as the case in the first embodiment (#605, #606). As a result, if it is found that the condition that the quarantine target indicated in the quarantine request message KMG is included in the internal network of the router 22 is satisfied (Yes in #606), the terminal device 32 that is the quarantine target is informed to the quarantine control portion 205 (#607).

The quarantine control portion 205 checks whether or not the terminal device 32 is connected to the switch 42, by comparing the quarantine target terminal IP address indicated in the quarantine request message KMG with the configuration definition information DTK (see FIG. 15). If the terminal device 32 is connected to the switch 42 (Yes in #609), the quarantine control portion 205 requests to transmit the quarantine request message KMG to the switch 42 in accordance with the configuration definition information DTK (#609).

Then, the message transmitting portion 203 sends out the quarantine request message KMG to the switch 42 (#610).

On the other hand, if the terminal device 32 of the quarantine target is connected directly to the router 22 (No in #608), the router 22 performs the quarantine process of the terminal device 32 as described in the first embodiment.

As shown in FIG. 19, if the message receiving portion 421 of the switch 42 receives the quarantine request message KMG from the router 22 (#621), the message inspecting portion 424 inspects whether or not the quarantine target indicated in the quarantine request message KMG is the terminal device 32 that is connected to the switch 42 (#622). If it is connected (Yes in #622), the terminal device 32 is informed to the quarantine control portion 425 (#623).

The quarantine control portion 425 inquires the MAC address solving portion 422 about whether or not it is possible to communicate with the terminal device 32 (#624).

The MAC address solving portion 422 checks whether or not it is possible to communicate with the terminal device 32 at present, by comparing the quarantine target terminal IP address indicated in the quarantine request message KMG with the IP address stored in the MAC address solution table 4L1 (#625), and it informs the result to the quarantine control portion 425 (#626).

The quarantine control portion 425 requests the quarantine processing portion 426 to perform the quarantine process of the terminal device 32 (#628) if it is possible to communicate with the terminal device 32 (Yes in #627).

Then, the quarantine processing portion 426 isolates the terminal device 32 temporarily for quarantine in the same manner as the case in the first embodiment (#629).

According to the second embodiment, the quarantine process of the terminal device 32 can be performed in the network environment in which the L2 switch is used, so that damage that may be caused by the harmful site can be prevented more securely than the conventional method.

Although both the router 22 and the switch 42 perform the inspection process of the quarantine request message KMG in the second embodiment, it is possible to adopt a structure in which one of them performs it.

### Third Embodiment

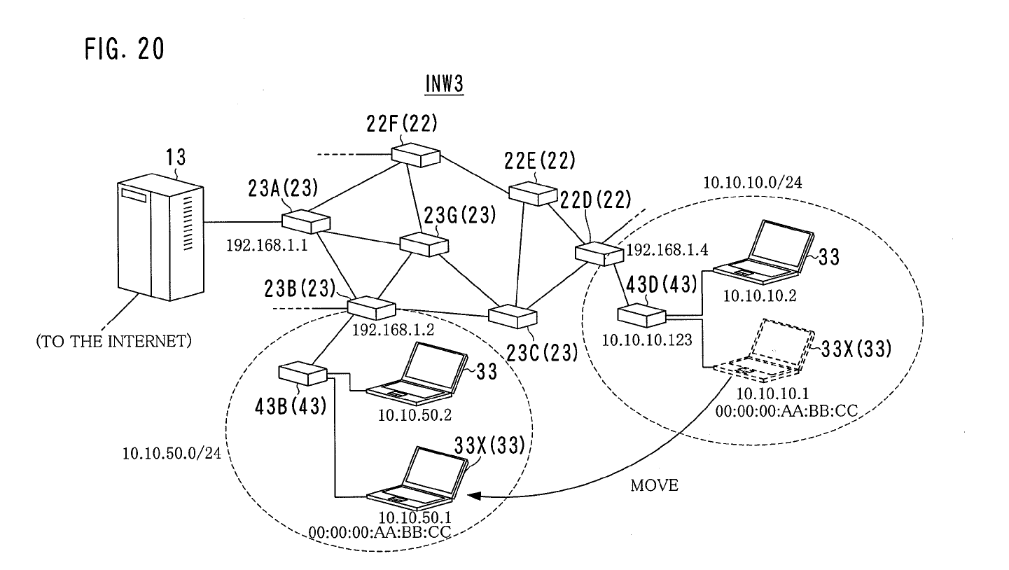

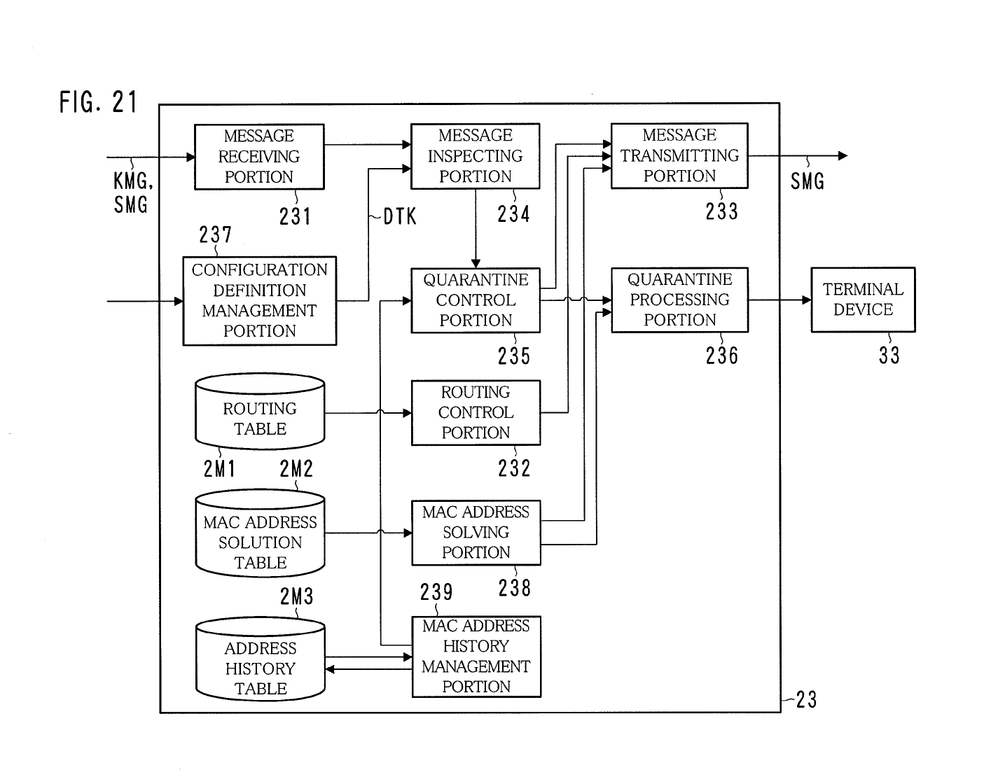

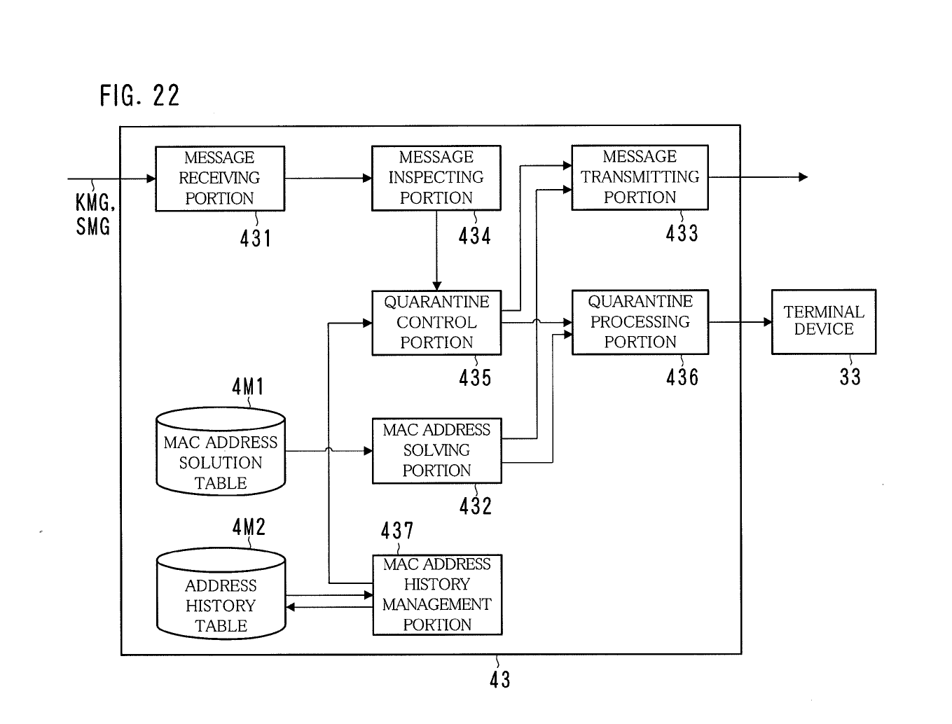

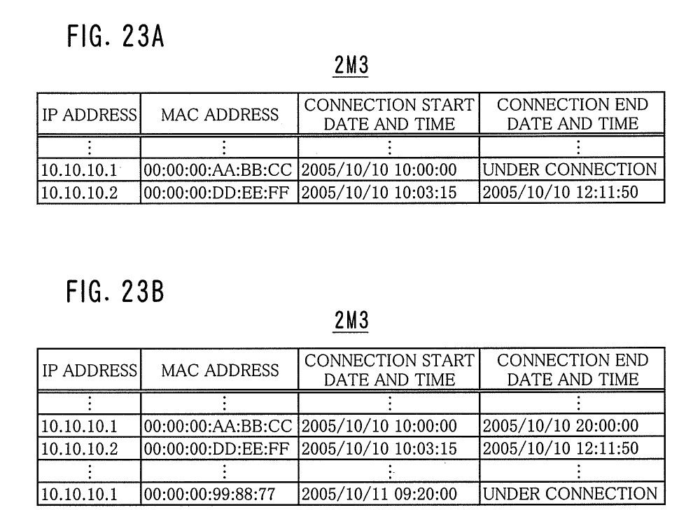

FIG. 20 is a diagram showing an example of a general structure of an intranet INW3 in a third embodiment, FIG. 21 is a diagram showing an example of a functional structure of a router 23 in the third embodiment, FIG. 22 is a diagram showing an example of a functional structure of a switch 43 in the third embodiment, and FIGS. 23A and 23B are diagrams showing an example of an address history table 2M3.

If the terminal device 3 is a note type personal computer or a mobile terminal such as a PDA, the user may carry the terminal device 3 and move, so as to use it in various LANs that constitute the intranet INW. In this case, the terminal device 3 is usually assigned with an IP address corresponding to each of the LANs by a DHCP server. There is the case where the router 2 or the switch 42 works as the DHCP server.

In addition, even in the case where the terminal device 3 is always used in the same LAN, the IP address of the terminal device 3 is not always the same if it is assigned with an IP address by the DHCP server.

If the IP address of the terminal device 3 is variable in this way, there is a case where not the terminal device 3 that is to be quarantined but other terminal device 3 is quarantined according to the method of the first or the second embodiment described above. Therefore, the third embodiment uses the following method for the quarantine process of the terminal device 3 in order to solve the above-mentioned problem.

As shown in FIG. 20, the intranet INW3 according to the third embodiment is made up of a proxy server 13, a plurality of routers 23 (23A, 23B, 23C and so on), a terminal device 33, a switch 43 and the like.

The structure of the proxy server 13 is the same as that of the proxy server 1 or 12 in the first or the second embodiment (see FIG. 2). The structure of the terminal device 33 is the same as that of the structure of the terminal device 3 or 32 in the first or the second embodiment. However, the structure of the quarantine request message KMG that is generated and transmitted by the proxy server 13 is different from that in the first or the second embodiment. This will be described later.

The router 23 is provided with a message receiving portion 231, a routing control portion 232, a message transmitting portion 233, a message inspecting portion 234, a quarantine control portion 235, a quarantine processing portion 236, a configuration definition management portion 237, a MAC address solving portion 238, a MAC address history management portion 239, a routing table 2M1, a MAC address solution table 2M2, an address history table 2M3 and the like, as shown in FIG. 21.

The message receiving portion 231 through the MAC address solving portion 238, the routing table 2M1 and the MAC address solution table 2M2 have basically the same roles as the message receiving portion 201 through the MAC address solving portion 208, the routing table 2K1 and the MAC address solution table 2K2, respectively, of the router 2 or 22 in the first or the second embodiment shown in FIG. 3.

The switch 43 is provided with a message receiving portion 431, a MAC address solving portion 432, a message transmitting portion 433, a message inspecting portion 434, a quarantine control portion 435, a quarantine processing portion 436, a MAC address history management portion 437, a MAC address solution table 4M1 and an address history table 4M2 as shown in FIG. 22.

The message receiving portion 431 through the quarantine processing portion 436 and the MAC address solution table 4M1 have basically the same roles as the message receiving portion 421 through the quarantine processing portion 426 and the MAC address solution table 4L1, respectively, of the switch 42 in the second embodiment shown in FIG. 16.

Hereinafter, process contents of the individual portions of the router 23 and the switch 43 will be described. Descriptions overlapping with the first or the second embodiment will be omitted.

The MAC address history management portion 239 manages the address history table 2M3 concerning the history of the relationship between the IP address and the MAC address of the terminal devices 33 that have been connected directly to the router 23.

The address history table 2M3 of the router 23 stores history data as shown in FIGS. 23A and 23B. The “IP address” and the “MAC address” indicate an IP address assigned by the DHCP server to the terminal device 33 that is connected to the router 23 and a MAC address that is unique to the terminal device 33, respectively. The “connection start date and time” indicates date and time when the IP address is assigned to the terminal device 33 so that the terminal device 33 is connected to the router 23. The “connection end date and time” indicates date and time when the connection ends so that the use of the IP address by the terminal device 33 is stopped. Note that if the connection end date and time is “under connection”, it means that the terminal device 33 is connected to the router 23 at present.

The MAC address history management portion 239 makes the address history table 2M3 accumulate or update the history data triggered by the update of the MAC address solution table 2M2 by the MAC address solving portion 238.

More specifically, the IP address is assigned to the terminal device 33 so that the connection between the devices is established. Then, the MAC address history management portion 239 makes the address history table 2M3 store the record indicating the IP address, the MAC address and date and time of the connection (connection start date and time), at the timing when the MAC address solving portion 238 stores the data indicating a new relationship between the IP address and the MAC address of the terminal device 33 in the routing table 2M1. At this time point, the connection end date and time is to be “under connection”. Then, the MAC address history management portion 239 updates the connection end date and time of the record to the date and time of the end at the timing when the connection is finished and the data indicating the relationship between the IP address and the MAC address is deleted from the routing table 2M1 by the MAC address solving portion 238.

For example, during the time period while the IP address “10.10.10.1” is assigned to the terminal device 33 having the MAC address “00:00:00:AA:BB:CC” in the router 23D for example, the address history table 2M3 of the router 23D indicates the history as shown in the second line from the bottom in FIG. 23A. After that, connection with the terminal device 33 is finished, and the IP address is assigned to another terminal device 33. Then, the address history table 2M3 changes as shown in FIG. 23B.

Note that contents of the history managed by the MAC address history management portion 437 are naturally different for each of the routers 23.

The MAC address history management portion 437 of the switch 43 also manages the address history table 4M2 concerning the history of the relationship between the IP address and the MAC address of the terminal devices 33 that have been connected directly to the switch 43, in the same manner as the MAC address history management portion 239 of the router 23.

The timing when the MAC address history management portion 437 adds the history data to the address history table 4M2 or updates the connection end date and time is also the same as the case of the MAC address history management portion 239, and it is based on the trigger from the MAC address solving portion 432.

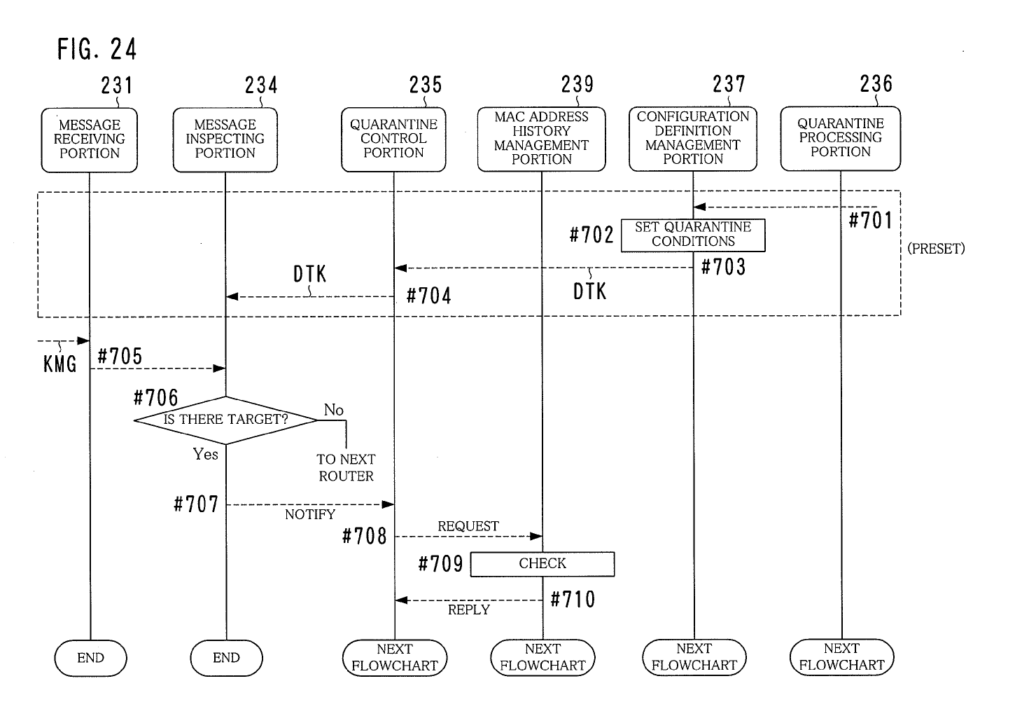

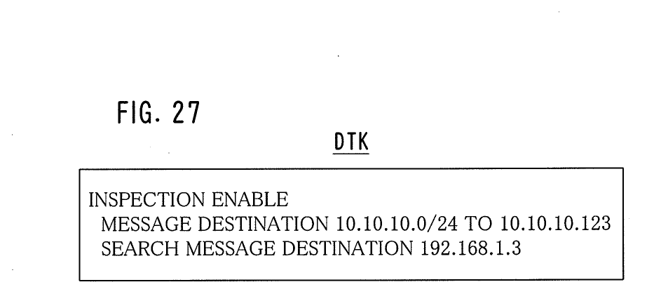

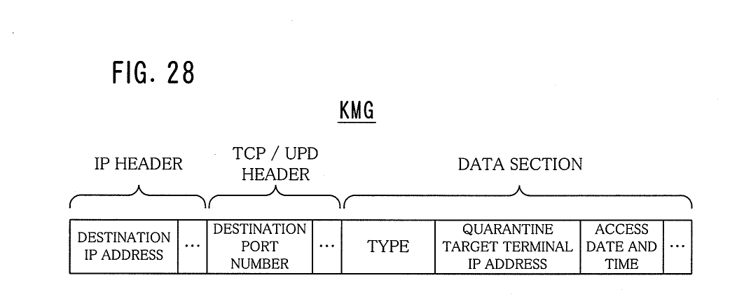

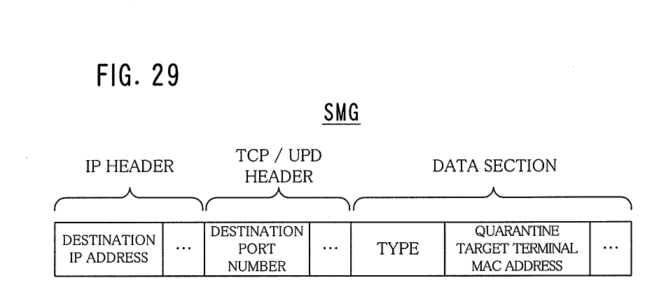

FIGS. 24-26 are flowcharts for explaining an example of a flow of the quarantine process of the router 23 that is connected directly to the terminal device 33, FIG. 27 is a diagram showing an example of configuration definition information DTK in the third embodiment, FIG. 28 is a diagram showing an example of a quarantine request message KMG in the third embodiment, and FIG. 29 is a diagram showing an example of a search request message SMG.

Next, a flow of the process performed by the proxy server 13, the router 23 and the switch 43 in the third embodiment will be described with reference to the flowcharts shown in FIGS. 24-26.

As shown in FIG. 24, the configuration definition management portion 237 of the router 23 receives the configuration definition information DTK that is entered by the administrator for preparation for a series of processes concerning the quarantine in the same manner as the case in the first or the second embodiment (#701, #702), and informs it to the quarantine control portion 235 (#703). Further, the quarantine control portion 235 informs the configuration definition information DTK to the message inspecting portion 234 (#704).

Note that the configuration definition information DTK as shown in FIG. 27 is set in the third embodiment. The setting of the second line has the same meaning as the configuration definition information DTK shown in FIG. 15, which is described in the second embodiment. The third line indicates other router 23 to which the search request message SMG that will be described later should be transmitted if the transmission is necessary.

When information of a newly found harmful site is obtained, the proxy server 13 identifies the terminal devices 33 that have already made access to the harmful site, generates the message to request (instruct) the quarantine process of the terminal devices 33, and transmits the message in the same manner as the case in the first or the second embodiment.

The quarantine request message KMG having the format as shown in FIG. 6 is generated in the first and the second embodiments, while the quarantine request message KMG having the format as shown in FIG. 28 is generated in the third embodiment. As understood from a comparison between FIG. 6 and FIG. 28, the quarantine request message KMG includes data of the same item as the quarantine request message KMG as well as data indicating the date and time when the terminal device 33 made access to the newly found harmful site (access date and time). This access date and time is based on the access log memory portion 1K2 (see FIG. 5).

This quarantine request message KMG is transmitted to the router 23 or the switch 43 in the LAN to which the destination IP address belongs, in the same manner as the case of the first or the second embodiment. Here, procedure of the process performed by the router 23 in the case where the terminal device 33 of the quarantine target is connected directly to the router 23 when it made access to the harmful site (i.e., the case of the same connection form as the first embodiment) will be described.

As shown in FIG. 24, when the message receiving portion 231 of the router 23 receives the quarantine request message KMG from the proxy server 13 or other router 23 (#705), the message inspecting portion 234 checks whether or not the quarantine target terminal IP address indicated in the quarantine request message KMG belongs to the internal network of the router 23 itself, in the same manner as the case in the first embodiment (#706). If it does not belong to the internal network (No in #706), the quarantine request message KMG is transmitted to the other router 23 in the same manner as the case in the first embodiment.

If it belongs to the internal network (Yes in #706), the quarantine target terminal IP address and the access date and time indicated in the quarantine request message KMG are informed to the quarantine control portion 235 (#707).

The quarantine control portion 235 request the MAC address history management portion 239 to investigate the terminal device 33 to which the quarantine target terminal IP address was assigned at the access date and time (#708).

The MAC address history management portion 239 checks the terminal device 33 to which the quarantine target terminal IP address was assigned, based on the address history table 2M3 (see FIGS. 23A and 23B) (#709). Then, the MAC address of the terminal device 33 is returned (#710).

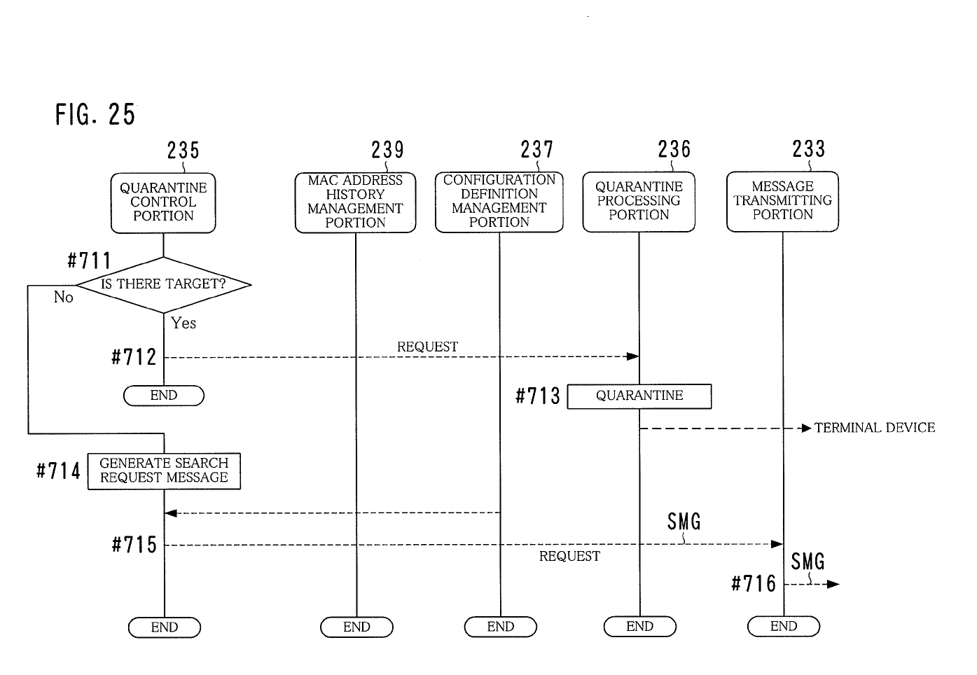

The process goes to the flow shown in FIG. 25. If the terminal device 33 having the MAC address is connected to the internal connection connector of the router 23 itself at present and it is able to communicate (Yes in #711), the quarantine control portion 235 requests the quarantine processing portion 236 to perform the quarantine process of the terminal device 33 having the MAC address (#712). The quarantine processing portion 236 performs the quarantine process in accordance with the request (#713).

Whether or not the terminal device 33 having the MAC address is connected to the internal connection connector of the router 23 itself at present should be inquired to the MAC address history management portion 239. The MAC address history management portion 239 checks the MAC address of the record in which the connection end date and time is “under connection” in the address history table 2M3, so as to decide whether or not it is connected to the router 23 itself and it is able to communicate.

If it is not connected to the router 23 itself (No in #711), there is a possibility that the terminal device 33 having the MAC address is used at present in a LAN of other router 23. Therefore, the quarantine control portion 235 generates the search request message SMG for requesting to search the terminal device 33 having the MAC address and performs the quarantine process (#714). This search request message SMG is made up of an IP header, a TCP/UDP header, a data section and the like as shown in FIG. 29.

The IP header indicates a destination IP address, a source IP address and the like. In particular, an IP address to which the search request message SMG defined by the configuration definition information DTK should be transmitted (see the third line in FIG. 27) is set to the destination IP address.

The TCP/UDP header indicates a destination port number, a source port number and the like. In particular, a port number in the application layer of the service that is requested this time, i.e., the search and quarantine service is set in the destination port number.

The data section indicates information such as a type, quarantine target terminal IP address and the like. The “type” indicates an identifier of the process that is requested by the message. Here, the identifier that indicates that it is a request of the quarantine process is shown. The MAC address checked by the MAC address history management portion 239 in the step #709 shown in FIG. 24 is set in the “quarantine target terminal MAC address”.

The quarantine control portion 235 makes the message transmitting portion 233 transmit the generated search request message SMG (#715, #716).

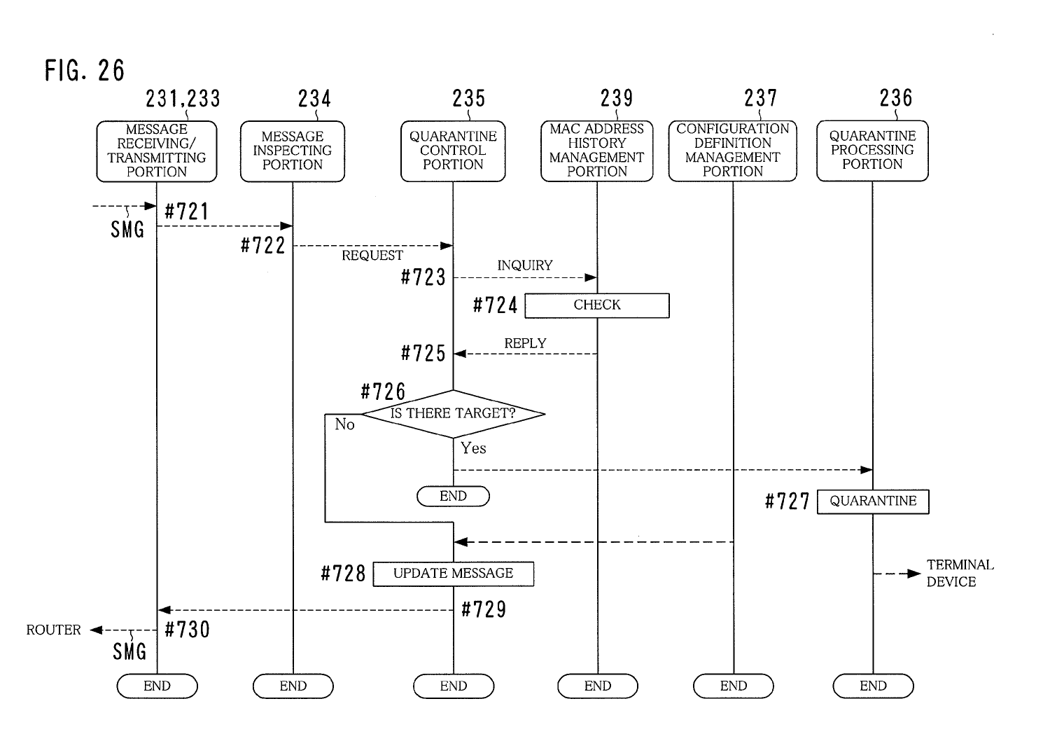

The router 23 that received the search request message SMG performs the quarantine process if the terminal device 33 that is the quarantine target is connected to the router 23 itself. If the terminal device 33 is not connected to the router 23, it transmits the search request message SMG to other router 23. These processes are performed in the procedure as shown in FIG. 26.

When the message receiving portion 231 receives the search request message SMG (#721), the message inspecting portion 234 inspects it so as to recognize that the request for search and quarantine of the quarantine target is made, and requests the quarantine control portion 235 to perform a process corresponding to the request (#722).

The quarantine control portion 235 inquires the MAC address history management portion 239 about whether or not the terminal device 33 having the quarantine target terminal MAC address indicated in the search request message SMG is currently connected to the router 23 itself (#723).

The MAC address history management portion 239 checks whether or not there is the terminal device 33 that uses the quarantine target terminal MAC address at present, based on the record in which the connection end date and time is “under connection” in the address history table 2M3 (#724) and returns the result (#725).

If the terminal device 33 having the quarantine target terminal MAC address is found (Yes in #726), the quarantine control portion 235 makes the quarantine processing portion 236 perform the quarantine process of the terminal device 33 (#727).

If the terminal device 33 having the quarantine target terminal MAC address is not found (No in #726), the message transmitting portion 233 transmits the search request message SMG to other router 23 (#730). In this case, however, the destination IP address of the search request message SMG should be changed to the IP address of the transmission destination defined in the configuration definition information DTK of the router 23 (see the third line in FIG. 27). Therefore, the search request message SMG is transmitted to the IP address. The process shown in FIG. 26 is performed also in other router 23 that received it.

If the terminal device 33 is connected to the switch 43, the switch 43 also performs basically the same process as the router 23 that is described above.

More specifically, the switch 43 receives the quarantine request message KMG that is transmitted from the proxy server 13 via the router 23 and checks the terminal device 33 to which the quarantine target terminal IP address indicated in the quarantine request message KMG is assigned at the access date and time indicated in it. The switch 43 checks whether or not the terminal device 33 is connected to the switch 43 itself at present and it is able to communicate. Then, if it is able to communicate, the quarantine of the terminal device 33 is performed.

If it is not connected, the search request message SMG in which the MAC address of the terminal device 33 is set to the quarantine target terminal MAC address is transmitted to other device.

The switch 43 that received the search request message SMG performs the quarantine process of the terminal device 33 if the terminal device 33 having the quarantine target terminal MAC address indicated in the search request message SMG is connected to itself at the present.

The method of transmitting the quarantine request message KMG and the search request message SMG is as described above.

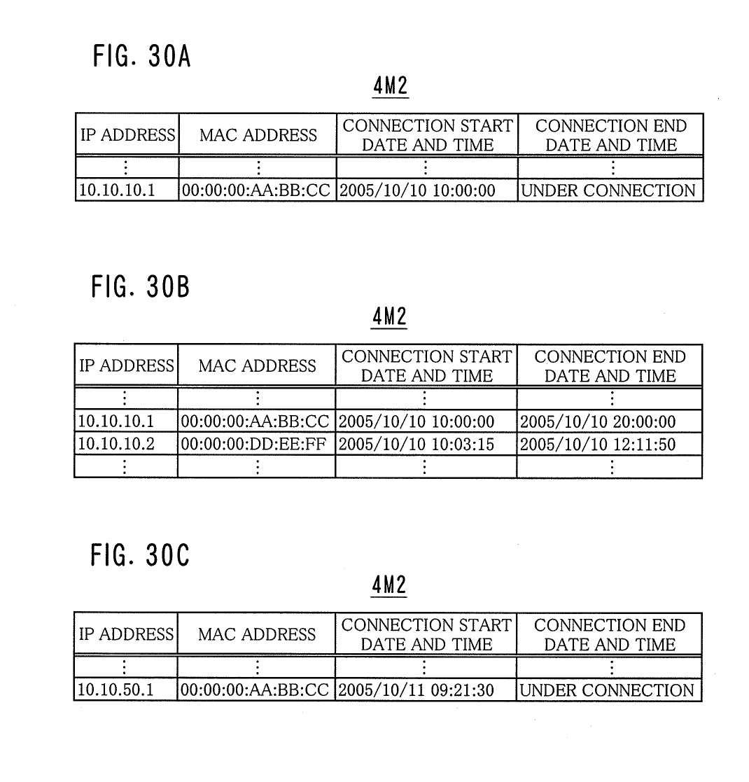

FIGS. 30A-30C are diagrams showing an example of an address history table 4M2. Next, flows of processes performed by the individual devices will be described with reference to an example of the case where the terminal device 33X having the MAC address “00:00:00:AA:BB:CC” makes access to a harmful site while it is connected to the switch 43D under the router 23D and is used, and after that it is connected to the switch 43B under the router 23B and is used, as shown in FIG. 20.

When the terminal device 33X is connected to the switch 43D and is assigned with the IP address “10.10.10.1”, the address history table 4M2 of the switch 43D stores the record indicating the history as shown in FIG. 30A.

Every time when the terminal device 33X obtains a Web page via the proxy server 13, the record indicating the history is stored in the access log memory portion 1K2 of the proxy server 13 (see FIG. 5). If the terminal device 33X tries to make access to a Web page of a harmful site that is already registered in the harmful site information memory portion 1K1 (see FIG. 4), the proxy server 13 refuses it. As described above, however, access to a Web page of a harmful site that is not registered yet in the harmful site information memory portion 1K1 is overlooked.

It is supposed that the terminal device 33X is separated from the switch 43D is connected to the switch 43B this time, and is assigned with IP address of “10.10.50.1”. Then, in the address history table 4M2 of the switch 43D, as shown in FIG. 30B, date and time when the connection between the terminal device 33X and the switch 43D is finished is stored in “connection end date and time” of the record of the IP address that was assigned to the terminal device 33X. On the other hand, the record indicating the IP address and the like that is assigned to the terminal device 33X is stored in the address history table 4M2 of the switch 43B as shown in FIG. 30C.

When the proxy server 13 obtains information of a newly found harmful site, it identifies the terminal devices 33 that have already made access to the harmful site. Here, it is supposed that the terminal device 33X is identified.

The proxy server 13 generates the quarantine request message KMG for requesting to perform the quarantine process of the terminal device 33X and sends it out. The destination of the quarantine request message KMG is the IP address that was used at the time point when the terminal device 33X made access to the harmful site. Therefore, the quarantine request message KMG is transmitted to the switch 43D via the routers 23 (e.g., via the routers 23A, 23B, 23C and 23D in this order).

If the quarantine target indicated in the quarantine request message KMG, i.e., the terminal device 33X is connected to the switch 43D itself, the switch 43D performs the quarantine process of the terminal device 33X. However, at this time point, as described above, the terminal device 33X is not connected to the switch 43D. Therefore, the switch 43D generates the search request message SMG in which the MAC address of the terminal device 33X is set as the quarantine target terminal MAC address and transmits it to the router 23D. Then, the search request message SMG is relayed to the routers 23 or the switch 43.

If the terminal device 33 having the quarantine target terminal MAC address indicated in the search request message SMG (i.e., terminal device 33X) is not connected to each of the routers 23 and the switch 43 itself, it transmits the search request message SMG to other router 23 or switch 43.

If the search request message SMG is transmitted to the switch 43B via various devices, the switch 43B confirms that the terminal device 33X is connected to itself and it is able to communicate, and performs the quarantine process for the terminal device 33X.

According to the third embodiment, even if the IP address of the terminal device 33 is variable, the quarantine process of the terminal device 33 can be performed. Therefore, damage that may be caused by the harmful site can be prevented more securely than the conventional method.

Although the first to the third embodiments describe the case where the network is divided by the routers 2, 22 and 23, the present invention can be applied to a case where it is divided by bridges.

It is possible to provide the server for the quarantine process to the intranets INW, INW2 and INW3. The routers 2, 22 and 23 and the switches 42 and 43 may be structured to make the server for the quarantine process perform the quarantine process of the terminal devices 3, 32 and 33.

Although the terminal devices 3, 32 and 33 that have obtained the data of the Web page provided by the harmful site are regarded as the quarantine target in the first to the third embodiments, it is possible to regard the terminal devices 3, 32 and 33 that have obtained an execution file (so-called an EXE file), a file of a screen saver or a macro file of an application too as the quarantine target.

Although a URL of the harmful site is registered in the proxy servers 1, 12 and 13 as described above with reference to FIG. 4 in the first to the third embodiments, it is possible to register a URL of harmful data of the Web page (a HTML file) or an execution file.

Alternatively, it is possible to register a part of a URL in the proxy servers 1, 12 and 13. For example, a part of a domain name in a URL of a harmful site may be registered with a server name and a protocol name in it omitted.

Although the first through the third embodiments describe the example of the case where the proxy servers 1, 12 and 13 perform the process of searching the quarantine target, it is possible to adopt a structure in which a firewall performs the process. Alternatively, it is possible that the router for connecting the intranet with the Internet (e.g., a dial up router) performs the process.

Furthermore, the structure of the entire or individual portions of the intranets INW, INW2 and INW3, the proxy servers 1, 12 and 13, the routers 2, 22 and 23, the switches 42 and 43 and the terminal devices 3, 32 and 33, the process contents, the process order, the configuration of the table and the like can be modified if necessary in accordance with the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A terminal device management system, comprising:
an identification information storing portion that stores data identification information for identifying harmful data that can cause damage or source site identification information for identifying a source site that provides the harmful data;
a data obtaining log storing portion that stores a data obtaining log indicating which terminal device has obtained which data or has obtained the data from which source site;
a data obtaining control portion that makes a terminal device obtain data that the terminal device tries to obtain if the data is neither the harmful data related to the data identification information stored in the identification information storing portion nor the harmful data provided by the source site related to the source site identification information, and that refuses the terminal device to obtain the data if the data is at least one of the harmful data;
a harmful data obtaining terminal device identifying portion that identifies a terminal device that has obtained the harmful data related to newly obtained data identification information or the harmful data provided by the source site related to newly obtained source site identification information, based on the data obtaining log stored in the data obtaining log storing portion; and
a quarantine processing portion that performs a quarantine process for the terminal device identified by the harmful data obtaining terminal device identifying portion.

2. A data relay device for relaying data provided by a server on the Internet to a terminal device in accordance with a request from the terminal device, the data relay device comprising:
an identification information storing portion that stores data identification information for identifying harmful data that can cause damage or source site identification information for identifying a source site that provides the harmful data;
a data obtaining log storing portion that stores a data obtaining log indicating which terminal device has obtained which data;
a data obtaining control portion that makes a terminal device obtain data that the terminal device tries to obtain if the data is neither the harmful data related to the data identification information stored in the identification information storing portion nor the harmful data provided by the source site related to the source site identification information, and that refuses the terminal device to obtain the data if the data is at least one of the harmful data;
a harmful data obtaining terminal device identifying portion that identifies a terminal device that has obtained the harmful data related to newly obtained data identification information or the harmful data provided by the source site related to newly obtained source site identification information, based on the data obtaining log stored in the data obtaining log storing portion; and
a quarantine requesting portion that requests a quarantine device to quarantine the terminal device identified by the harmful data obtaining terminal device identifying portion.

3. The data relay device according to claim 2, wherein the quarantine requesting portion requests a quarantine device that is connected to the terminal device identified by the harmful data obtaining terminal device identifying portion to quarantine the terminal device.

4. An internetwork connection device for connecting a plurality of networks to each other, comprising:
a terminal device identification information receiving portion that receives terminal device identification information for identifying a terminal device to be quarantined;
a quarantine processing portion that performs a process for quarantine of the terminal device if the terminal device related to the terminal device identification information received by the terminal device identification information receiving portion belongs to an internal network of the internetwork connection device; and
a terminal device identification information transmitting portion that transmits the terminal device identification information to other internetwork connection device if the terminal device related to the terminal device identification information received by the terminal device identification information receiving portion does not belong to the internal network of the internetwork connection device.

5. The internetwork connection device according to claim 4, further comprising an address log information storing portion that stores address log information indicating an MAC address of a terminal device belonging to the internal network of the internetwork connection device, an IP address assigned to the terminal device, and a period while the IP address was assigned to the terminal device, wherein
the terminal device identification information receiving portion receives first terminal device identification information that indicates an IP address of a terminal device to be quarantined as the terminal device identification information and receives date and time information indicating date and time when data provided by a harmful site was given to the terminal device together with the first terminal device identification information, or receives second terminal device identification information indicating a MAC address of the terminal device to be quarantined as the terminal device identification information,
when the first terminal device identification information is received, the quarantine processing portion performs a process for quarantine of the terminal device, if the terminal device that was assigned with the IP address indicated in the first terminal device identification information at the date and time indicated in the date and time information that was received together with the first terminal device identification information belongs to the internal network of the internetwork connection device at present, and when the second terminal device identification information is received, it performs the process for quarantine of the terminal device, if the terminal device having the MAC address indicated in the second terminal device identification information belongs to the internal network of the internetwork connection device at present, and
the terminal device identification information transmitting portion transmits the second terminal device identification information indicating the MAC address of the terminal device that was assigned with the IP address indicated in the received first terminal device identification information at the date and time indicated in the date and time information that was received together with the first terminal device identification information, based on the address log information stored in the address log information storing portion.

6. The internetwork connection device according to claim 4, wherein if the terminal device related to the terminal device identification information is connected to a layer II switch having a quarantine function in the internal network of the internetwork connection device, the quarantine processing portion makes the layer II switch perform the quarantine of the terminal device.

7. A method for quarantining a terminal device, comprising:
storing data identification information for identifying harmful data that can cause damage or source site identification information for identifying a source site that provides the harmful data in an identification information storing portion;
storing a data obtaining log indicating which terminal device has obtained which data or has obtained the data from which source site in a data obtaining log storing portion;
making a terminal device obtain data that the terminal device tries to obtain if the data is neither the harmful data related to the data identification information stored in the identification information storing portion nor the harmful data provided by the source site related to the source site identification information, while refusing the terminal device to obtain the data if the data is at least one of the harmful data;
identifying a terminal device that has obtained the harmful data related to newly obtained data identification information or the harmful data provided by the source site related to newly obtained source site identification information, based on the data obtaining log stored in the data obtaining log storing portion; and
quarantining the identified terminal device.

8. A method for quarantining a terminal device in an intranet made up of a plurality of LANs, the method comprising:
making an internetwork connection device that connects a plurality of LANs with each other receive terminal device identification information for identifying a terminal device to be quarantined;
making the internetwork connection device perform a process for quarantining the terminal device if the terminal device related to the received terminal device identification information belongs to the LAN of an internal network side of the internetwork connection device; and
making the internetwork connection device transmit the terminal device identification information to other internetwork connection device if the terminal device related to the received terminal device identification information does not belong to the LAN of the internal network side of the internetwork connection device.

9. A computer program product for controlling a relay device that relays data obtained from a server on the Internet to a terminal device, the computer program making the relay device perform the process comprising:
retrieving data identification information for identifying harmful data that can cause damage or source site identification information for identifying a source site that provides the harmful data from an identification information storing portion every time when a terminal device requests data;
relaying the data requested by the terminal device if the requested data is neither the harmful data related to the data identification information stored in the identification information storing portion nor the harmful data provided by the source site related to the source site identification information;
refusing to relay the data requested by the terminal device if the requested data is one of the harmful data;
storing data relay log indicating which data was relayed to which terminal device or from which source site the data was relayed, in a data relay log storing portion, every time when data is relayed to a terminal device;
identifying a terminal device to which the harmful data related to newly obtained data identification information or the harmful data provided by the source site related to newly obtained source site identification information has been relayed, based on the data relay log stored in the data relay log storing portion; and
requesting a quarantine device to quarantine the identified terminal device.

10. A computer program product for controlling an internetwork connection device that connects a plurality of LANs with each other, the computer program making the internetwork connection device perform the process comprising:
receiving terminal device identification information for identifying a terminal device to be quarantined;
performing a process for quarantining the terminal device if the terminal device related to the received terminal device identification information belongs to a LAN of an internal network side of the internetwork connection device; and
performing a process for transmitting the terminal device identification information to other internetwork connection device if the terminal device related to the received terminal device identification information does not belong to the LAN of the internal network side of the internetwork connection device.
